(19) United States
(12) Patent Application Publication
(10) Pub. No.: US 2026/0353064 A1
(43) Pub. Date: Nov. 5, 2026

(54) SOUNDING OPERATION FOR RELAY COMMUNICATION

(71) Applicant: Ofinno, LLC, Reston, VA (US)

(72) Inventors: Jiayi Zhang, Rockville, MD (US); Leonardo Alisasis Lanante, Reston, VA (US); Esmael Hejazi Dinan, McLean, VA (US); Jeongki Kim, Fairfax, VA (US); Serhat Erkucuk, Reston, VA (US); Tuncer Baykas, Reston, VA (US)

(73) Assignee: Ofinno, LLC, Reston, VA (US)

(21) Appl. No.: 19/719,393

(22) Filed: Jun. 25, 2026

Related U.S. Application Data
(63) Continuation of application No. PCT/US2024/061892, filed on Dec. 26, 2024.
(60) Provisional application No. 63/615,823, filed on Dec. 29, 2023.

(51) Int. Cl. H04W 8/18; H04B 7/06; H04L 25/02; H04W 8/22

(52) U.S. Cl. CPC H04W 8/183; H04B 7/0658; H04L 25/0224; H04W 8/22

(57) ABSTRACT

A first station (STA) receives from a second STA a first frame: indicating a first physical layer protocol data unit (PPDU) to be transmitted by the second STA, where the first PPDU is for estimation, by the first STA, of a first channel from the second STA to the first STA; and requesting that the first STA transmit to a third STA a second frame, after receiving the first PPDU, the second frame indicating a second PPDU to be transmitted by the first STA to the third STA, where the second PPDU is for estimation, by the third STA, of a second channel from the first STA to the third STA. The first STA receives from the second STA the first PPDU; transmits, to the third STA, the second frame after receiving the first PPDU; and transmits, to the third STA, the second PPDU after transmitting the second frame.

### CROSS-REFERENCE TO RELATED APPLICATIONS

This application is a continuation of International Application No. PCT/US2024/061892, filed Dec. 26, 2024, which claims the benefit of U.S. Provisional Application No. 63/615,823, filed Dec. 29, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example Medium Access Control (MAC) frame format.

FIG. 4 illustrates an example management frame which may be used as an action frame.

FIG. 5 illustrates an example control frame which may be used as a trigger frame.

FIG. 6 illustrates an example data frame which may be used as a Quality of Service (QoS) null frame.

FIG. 7 illustrates an example format of a physical layer (PHY) protocol data unit (PPDU).

FIG. 8 illustrates an example of a sub-1 GHz (S1G) relay architecture.

FIG. 9 illustrates an example of source-relay-destination link.

FIG. 10 is an example that illustrates relaying with no transmission opportunity (TXOP) protection.

FIG. 11 illustrates an example of Request-to-Send (RTS)/Clear-to-Send (CTS) procedure.

FIG. 12 is an example that illustrates relaying with TXOP protection.

FIG. 13 illustrates an example null data PPDU (NDP) announcement (NDPA) frame format.

FIG. 14 illustrates an example enhanced high throughput (EHT) compressed beamforming/channel quality indication (CQI) frame.

FIG. 15 illustrates an example EHT non-trigger-based (non-TB) sounding sequence.

FIG. 16 illustrates an example EHT trigger based (TB) sounding sequence.

FIG. 17 illustrates an example sounding procedure for relaying.

FIG. 18 is an example that illustrates a sounding procedure for relay communication according to an embodiment.

FIG. 19 is an example that illustrates a sounding procedure for relay communication according to an embodiment.

FIG. 20 is an example that illustrates a sounding procedure for relay communication according to an embodiment.

FIG. 21 is an example that illustrates a sounding procedure for relay communication according to an embodiment.

FIG. 22 is an example that illustrates a sounding procedure for relay communication according to an embodiment.

FIG. 23 illustrates an example control frame which may be used according to embodiments.

FIG. 24 illustrates an example control frame which may be used according to embodiments.

FIG. 25 illustrates an example action frame which may be used according to embodiments.

FIG. 26 illustrates an example action frame which may be used according to embodiments.

FIG. 27 illustrates an example process according to an embodiment of the present disclosure.

FIG. 28 illustrates an example process according to an embodiment of the present disclosure.

FIG. 29 illustrates an example process according to an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

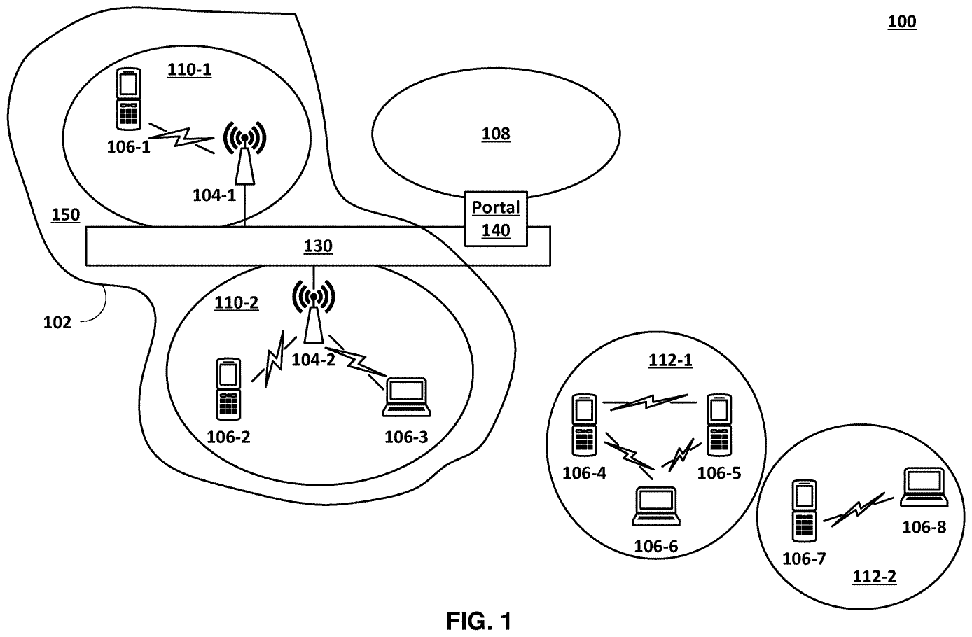

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 520 MHz by bonding together multiple 20 MHz channels.

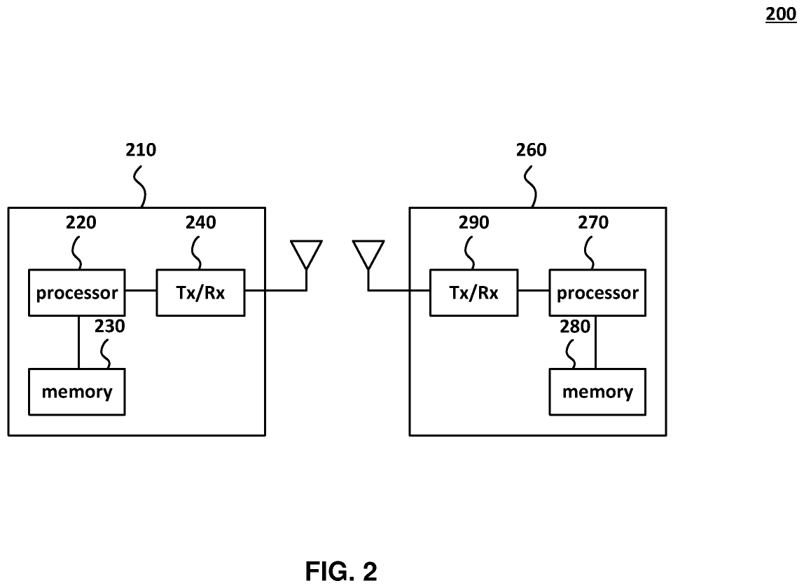

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

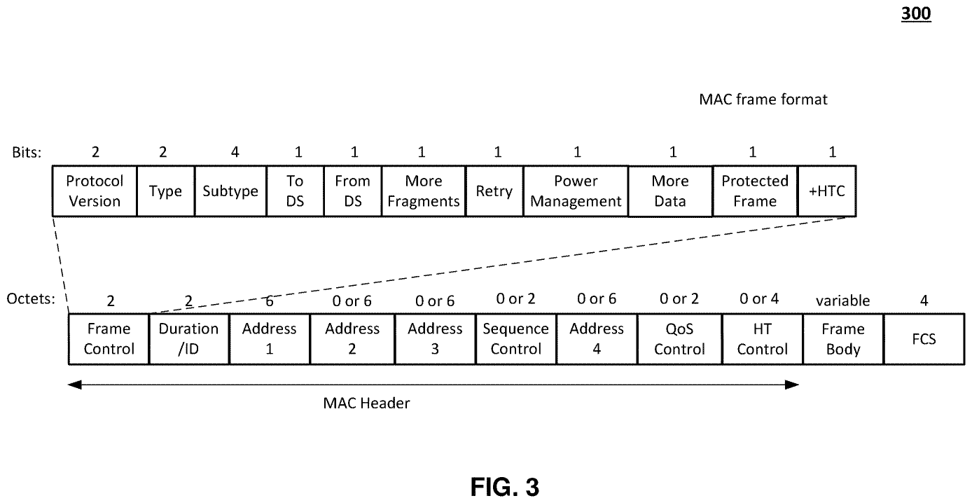

FIG. 3 illustrates an example format of a MAC frame 300. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, MAC frame 300 includes a MAC header, a variable length frame body, and a frame check sequence (FCS).

The MAC header includes a frame control field, an optional duration/ID field (not in PS-Poll frames), address fields, an optional sequence control field, an optional QoS control field (only in QoS Data frames), and an optional high throughput (HT) control field (only in +HTC frames).

The frame control field includes the following subfields: protocol version, type, subtype, To DS, From DS, more fragments, retry, power management, more data, protected frame, and high throughput control (+HTC).

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS subtype data frame, which is a data frame that contains a QoS control field in its MAC header. The second MSB of the subtype field, bit 6 (B6) of the frame control field, when set to 1 in data subtypes, indicates a data frame that contains no frame body field.

The To DS subfield indicates whether a data frame is destined to the DS. The From DS subfield indicates whether a data frame originates from the DS.

The more fragments subfield is set to 1 in all data or management frames that have another fragment to follow of the MAC service data unit (MSDU) or MAC management protocol data unit (MMPDU) carried by the MAC frame. It is set to 0 in all other frames in which the more fragments subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The More Data subfield indicates to a STA in power save (PS) mode that bufferable units (BUs) are buffered for that STA at the AP. The more data subfield is valid in individually addressed data or management frames transmitted by an AP to a STA in PS mode. The more data subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that MAC frame 300 contains an HT control field. A frame that contains the HT Control field is referred to as a +HTC frame. A Control Wrapper frame is a +HTC frame.

The duration/ID field of the MAC header indicates various contents depending on frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), and the 2 most significant bits (MSB) are both set to 1. In other frames sent by STAs, the duration/ID field contains a duration value (in microseconds) which is used by a recipient to update a network allocation vector (NAV). The NAV is a counter that indicates to a STA an amount of time during which it must defer from accessing the shared medium.

There can be up to four address fields in the format of MAC frame 300. These fields are used to indicate the basic service set identifier (BSSID), source address (SA), destination address (DA), transmitter address (TA), and receiver address (RA). Certain frames might not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which MAC frame 300 belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field. The control frame subtype for which HT control field is present is the control wrapper frame. A control frame that is described as +HTC (e.g., a request to send (RTS)+HTC, clear to send (CTS)+HTC, block acknowledgment (BlockAck)+HTC or block acknowledgment request (BlockAckReq)+HTC frame) implies the use of the control wrapper frame to carry that control frame.

The frame body field is a variable length field that contains information specific to individual frame types and subtypes. It may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

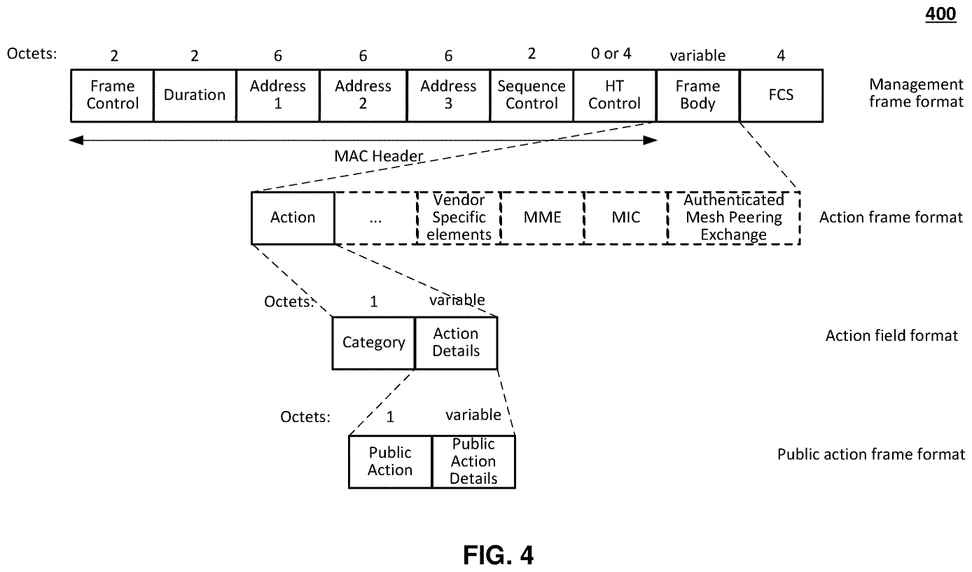

FIG. 4 illustrates an example management frame 400 which may be used as an action frame. In an example, management frame 400 includes a MAC header, a variable length frame body, and a frame check sequence (FCS). The MAC header includes a frame control field, a duration field, an address 1 field, an address 2 field, an address 3 field, a sequence control field, and an optional HT control field. The presence of the HT control field is determined by the setting of a +HTC subfield of the frame control field.

As shown in FIG. 4, when used as an action frame, the frame body of management frame includes an action field, vendor specific elements, management message integrity code element (MME), message integrity code (MIC), and an authenticated mesh peering exchange element.

The action field includes a category field and an action details field. The action field provides a mechanism for specifying extended management actions. The category field indicates a category of the action frame. The action details field contains the details of the action requested by the action frame. For example, the action frame may be a public action frame. As shown in FIG. 4, in the public action frame format, the action details field includes a public action field, in the octet immediately after the category field, followed by a variable length public action details field.

One or more vendor specific elements are optionally present. These elements are absent when the category subfield of the Action field is vendor-specific.

The MME is present when management frame protection is negotiated, the frame is a group addressed robust Action frame, and (MBSS only) the category of the action frame does not support group addressed privacy as indicated by category values; otherwise not present.

The MIC element is present in a self-protected action frame if a shared pairwise master key (PMK) exists between the sender and recipient of this frame; otherwise not present.

The authenticated mesh peering exchange element is present in a self-protected action frame if a shared PMK exists between the sender and recipient of this frame; otherwise not present.

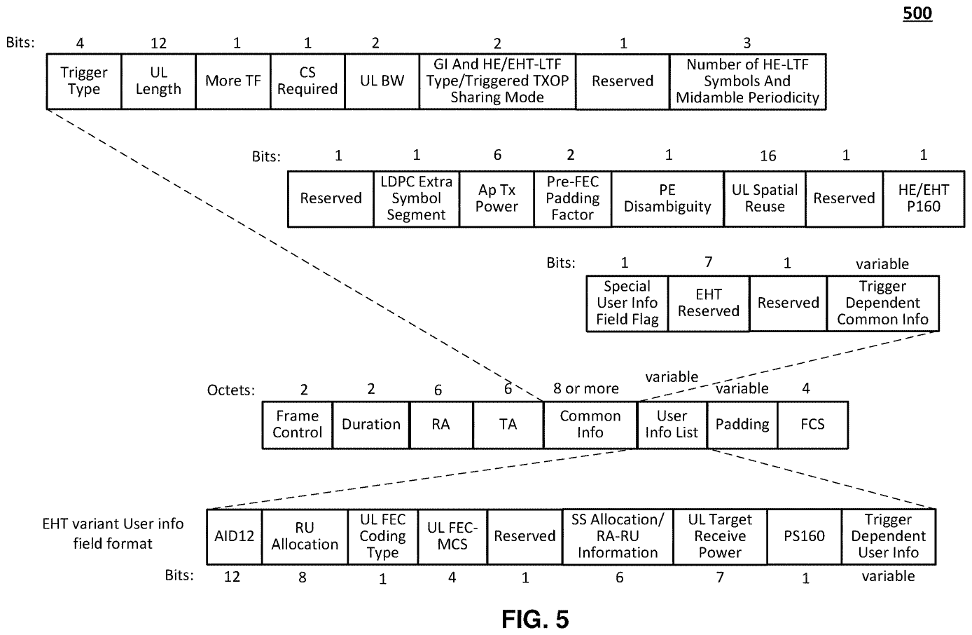

FIG. 5 illustrates an example format of a trigger frame 500. Trigger frame 500 may be used by an AP to allocate resources for and solicit one or more TB PPDU transmissions from one or more STAs. Trigger frame 500 may also carry other information required by a responding STA to transmit a TB PPDU to the AP.

As shown in FIG. 5, trigger frame 500 includes a Frame Control field, a Duration field, a receiver address (RA) field, a transmitter address (TA) field, a Common Info field, a User Info List field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 500 if trigger frame 500 is addressed to STAs that belong to a single BSS. The TA field is the transmitted BSSID if trigger frame 500 is addressed to STAs from at least two different BSSs of the multiple BSSID set.

The Common Info field specifies a trigger frame type of trigger frame 500, a transmit power of trigger frame 500 in dBm, and several key parameters of a TB PPDU that is transmitted by a STA in response to trigger frame 500. The trigger frame type of a trigger frame used by an AP to receive QoS data using UL MU operation is referred to as a basic trigger frame. A non-EHT non-AP HE STA interprets the Common Info field as HE variant. A non-AP EHT STA interprets the Common Info field as HE variant if B54 and B55 in the Common Info field are equal to 1; and interprets the Common Info field as EHT variant otherwise. The HE variant Common Info field and the EHT variant Common Info field use the same encoding method for the Trigger Type, UL Length, More TF, CS Required, LDPC Extra Symbol Segment, AP TX Power, Pre-FEC Padding Factor, PE Disambiguity, and Trigger Dependent Common Info subfields.

The User Info List field contains zero or more User Info fields. There are three variants for the User Info field, which are the Special User Info field, the EHT variant User Info field, and the HE variant User Info field.

The Special User Info field is a User Info field that does not carry the user specific information but carries the extended common information not provided in the Common Info field. If the Special User Info field is included in the Trigger frame, then the Special User Info Field Flag subfield of the EHT variant Common Info field is set to 0, otherwise it is set to 1. The Special User Info field is identified by an AID12 value of 2007 and is optionally present in a Trigger frame that is generated by an EHT AP. The Special User Info field, if present, is located immediately after the Common Info field of the Trigger frame and carries information for the U-SIG field of a solicited EHT TB PPDU. The PHY Version Identifier subfield indicates the PHY version of the solicited TB PPDU that is not an HE TB PPDU. The PHY Version Identifier subfield is set to 0 for EHT. Other values from 1 to 7 are reserved. The UL Bandwidth (BW) Extension subfield, together with the UL BW subfield in the Common Info field, indicates the bandwidth of the solicited TB PPDU from the addressed EHT STA (i.e., the bandwidth in the U-SIG field of the EHT TB PPDU). The EHT Spatial Reuse n subfield carries the values to be included in the corresponding Spatial Reuse n subfield in the U-SIG field of the EHT TB PPDU. The U-SIG Disregard And Validate subfield carries the values to be included in the Disregard and Validate subfields of the U-SIG field of the solicited EHT TB PPDUs. The presence and length of the Trigger Dependent User Info subfield in the Special User Info field depends on the variant of the Trigger frame.

The EHT variant User Info field contains a User Info field per STA addressed in trigger frame 500. The per STA User Info field includes, among others, an AID12 subfield, an RU Allocation subfield, a UL FEC Coding Type subfield, a UL EHT-MCS subfield, a Reserved subfield, a Spatial Stream (SS) Allocation/RA-RU information subfield, a UL Target Receive Power subfield, and a Power Save (PS) 160 subfield to be used by a STA in a TB PPDU transmitted in response to trigger frame 500, and a Trigger Dependent User Info subfield. The RU Allocation subfield in an EHT variant User Info field in a Trigger frame that is not an MU-RTS Trigger frame, along with the UL BW subfield in the Common Info field, the UL BW Extension subfield in the Special User Info field, and the PS160 subfield in the EHT variant User Info field, identifies the size and the location of the RU or MRU. The values of PS160 subfield and B0 of RU Allocation subfield indicate the 80 MHz frequency subblock in which the RU or MRU is located for 26-tone RU, 52-tone RU, 106-tone RU, 242-tone RU, 484-tone RU, 996-tone RU, 52+26-tone RU, and 106+26-tone RU. The values of PS160 subfield indicates the 160 MHz segment in which the RU or MRU is located for 2□996-tone RU, 996+484-tone MRU, and 996+484+242-tone MRU. The UL FEC Coding Type subfield of the User Info field indicates the code type of the solicited EHT TB PPDU. The UL FEC Coding Type subfield is set to 0 to indicate BCC and set to 1 to indicate LDPC. The UL EHT-MCS subfield of the User Info field indicates the EHT-MCS of the solicited EHT TB PPDU. The SS Allocation subfield of the EHT variant User Info field indicates the spatial streams of the solicited EHT TB PPDU. The UL Target Receive Power subfield indicates the expected receive signal power, measured at the AP's antenna connector and averaged over the antennas, for the EHT portion of the EHT TB PPDU transmitted on the assigned RU. The Trigger Dependent User Info subfield can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA. The RA-RU Information subfield is reserved in the EHT variant User Info field.

The Padding field is optionally present in frame 400 to extend the frame length to give recipient STAs enough time to prepare a response for transmission one SIFS after the frame is received. The Padding field, if present, is at least two octets in length and is set to all 1s.

The FCS field is used by a STA to validate a received frame and to interpret certain fields from the MAC headers of a frame.

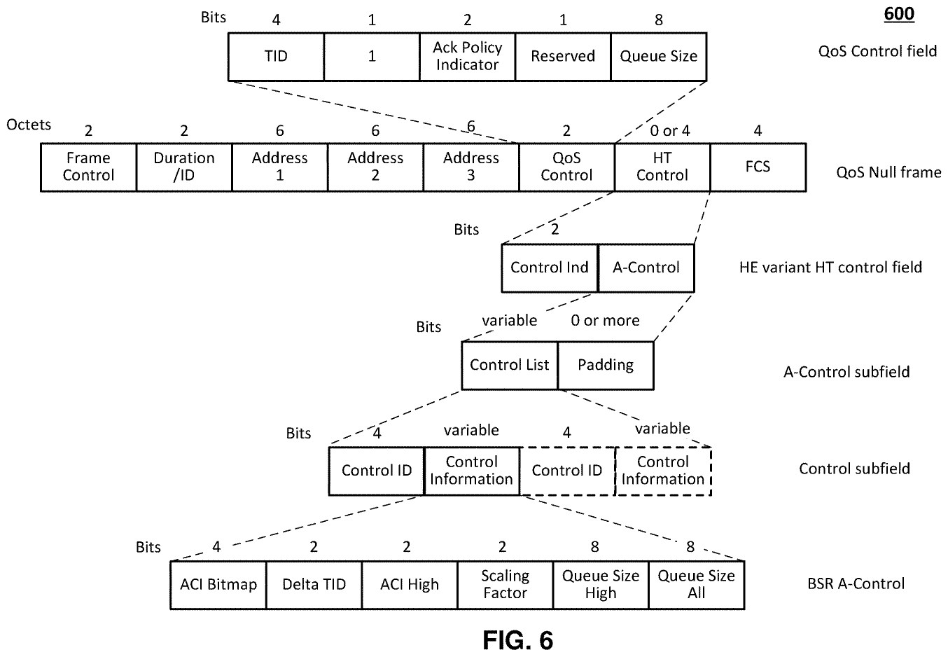

FIG. 6 illustrates an example data frame 600 which may be used as a QoS null frame. A QoS null frame refers to a QoS data frame with an empty frame body. QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an acknowledgment (Ack) policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the Ack policy followed upon delivery of the MPDU (e.g., normal Ack, implicit block Ack request, no Ack, block Ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine the TXOP duration assigned to the STA or to determine the uplink (UL) resources assigned to the STA.

In a frame sent by or to a non-high efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, SF.

A STA obtains the queue size, QS, from a received QoS control field, which contains a scaling factor, SF, and an unscaled value, UV, as follows:
QS=
   16×UV, if SF is equal to 0;
   1024+256×UV, if SF is equal to 1;
   17 408+2048×UV, if SF is equal to 2;
   148 480+32 768×UV, if SF is equal to 3 and UV is less than 62;
   >2 147 328, if SF equal to is 3 and UV is equal to 62;
   Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include an aggregated control (A-Control) subfield. The A-Control subfield may include a control list subfield including one or more control subfields.

The control subfield may be a BSR control subfield, which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

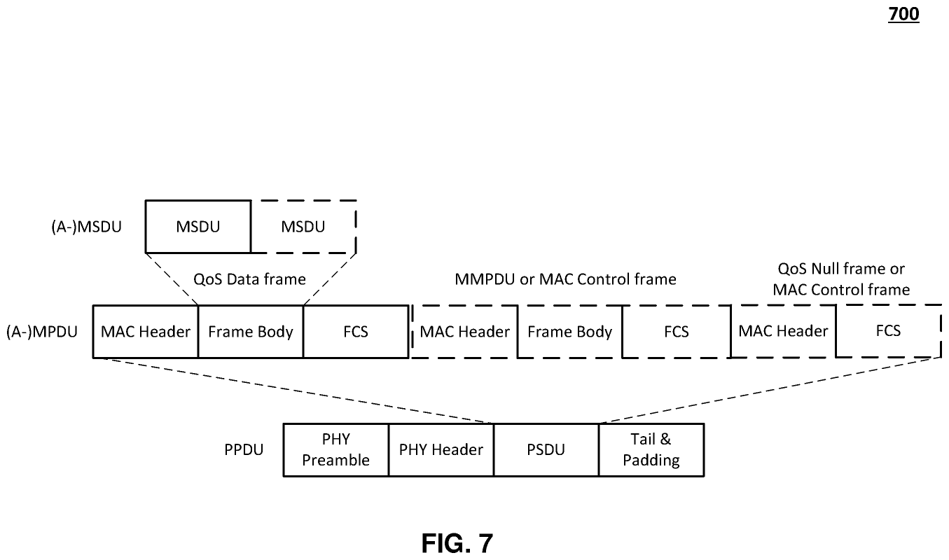

FIG. 7 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in an UP parameter. An A-MPDU may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

A multi-link device (MLD) is an entity capable of managing communication over multiple links. The MLD may be a logical entity and may have more than one affiliated station (STA). An MLD may be an access point MLD (AP MLD) where a STA affiliated with the MLD is an AP STA (or an AP). An MLD may be a non-access point MLD (non-AP MLD) where a STA affiliated with the MLD is a non-AP STA (or an STA).

Communication across different frequency bands/channels may occur simultaneously, or not, depending on the capabilities of both the communicating AP MLD and non-AP MLD.

An MLD may have a single MAC service access point (MAC-SAP) to the LLC layer, which includes a MAC data service. The MLD may support multiple MAC sublayers, coordinated by a sublayer management entity (SME). Each AP STA (or non-AP STA) affiliated with an AP MLD (or non-AP MLD) has a different MAC address within the MLD.

The SME is responsible for coordinating the MAC sublayer management entities (MLMEs) of the affiliated STAs of the MLD to maintain a single robust security network association (RSNA) key management entity as well as a single IEEE 802.1X Authenticator or Supplicant for multi-link operation (MLO).

Multi-link operation (MLO) procedures allow a pair of MLDs to discover, synchronize, (de)authenticate, (re)associate, disassociate, and manage resources with each other on any common bands or channels that are supported by both MLDs. The Authenticator and the MAC-SAP of an AP MLD may be identified by the same AP MLD MAC address. The Supplicant and the MAC-SAP of a non-AP MLD may be identified by the same non-AP MLD MAC address.

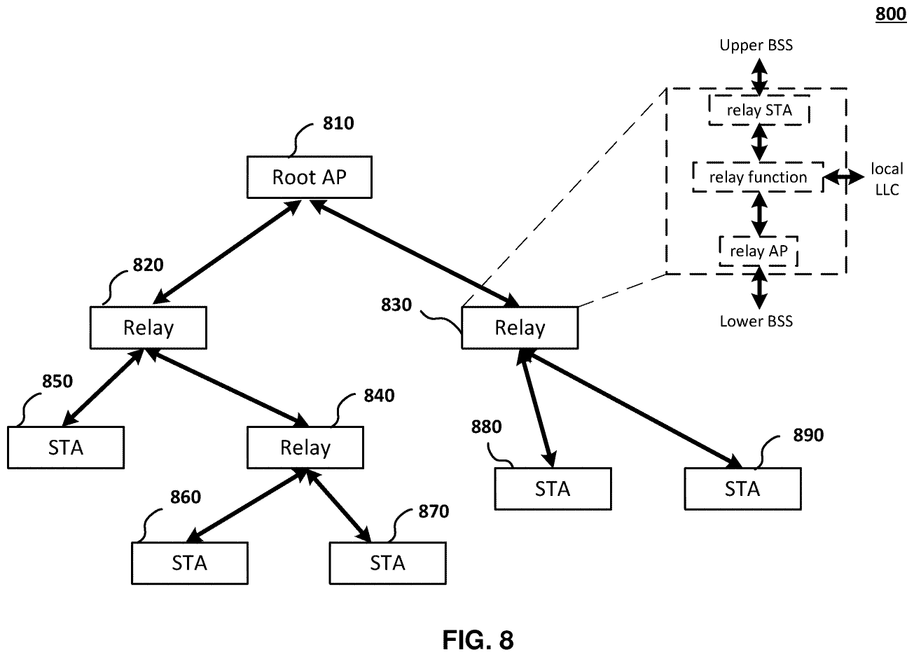

FIG. 8 illustrates an example sub-1 GHz (S1G) relay architecture 800. Example S1G relay architecture 800 may be an example according to the S1G relay operation as defined in section 10.54.1 of the IEEE 802.11 standard draft “IEEE P802.11-REVme™/D2.1, January 2023.” As shown in FIG. 8, example S1G relay architecture 800 may include a root AP 810, relays 820, 830 and 840, and STAs 850, 860, 870, 880 and 890.

S1G relay is a mechanism for expanding the coverage area of an AP, referred to as the root AP. In example S1G relay architecture 800, the S1G relay mechanism is being used to expand the coverage area of root AP 810.

As shown in FIG. 8, S1G relays 820, 830 and 840 may each comprise a relay AP, a relay STA, and a relay function. The relay STA communicates with an upper BSS, whereas the relay AP communicates with a lower BSS. The relay function performs local reception or selective forwarding of MSDUs between the relay STA and the relay AP, based on destination address. In an example, relays 820 and 830 are associated with root AP 810. Relay 840 may be associated with relay 820. In an example, STA 850 is associated with relay 820. STAs 860 and 870 may be associated with relay 840. STAs 880 and 890 may be associated with relay 830.

In an example, frames from STA 850 are forwarded via the relay function of relay 820 (from the relay AP to the relay STA of relay 820) to root AP 810. In the reverse direction, frames from root AP 810 are forwarded to STA 850 via the relay function of relay 820 (from the relay STA to the relay AP of relay 820). Similarly, STAs 880 and 890 may communicate with root AP 810 via relay 830 in both directions (e.g., uplink and downlink). On the other hand, STAs 860 and 870 may use relays 840 and 820 consecutively to communicate with root AP 810.

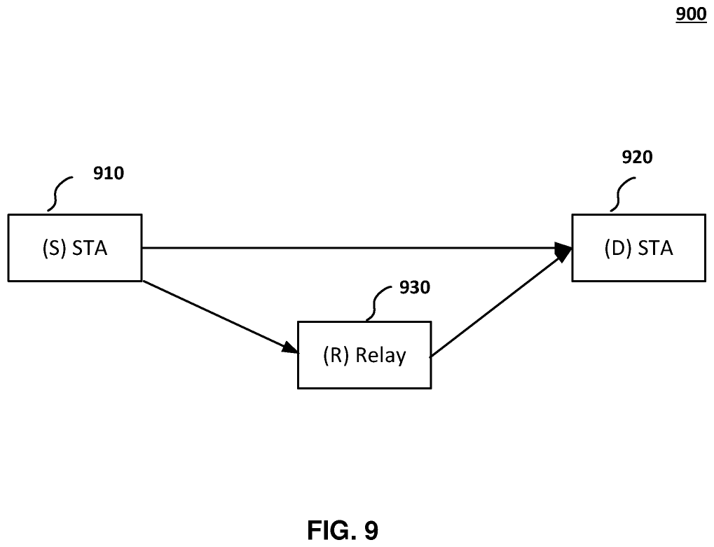

FIG. 9 illustrates an example 900 of a source-relay-destination link. As shown in FIG. 9, example 900 may comprise a STA 910 as a source STA, a STA 920 as a destination STA, and a relay 930.

STA 910 may be a non-AP STA or an AP STA. Similarly, STA 920 may be a non-AP STA or an AP STA. Relay 930 may comprise a relay AP, a relay STA, and a relay function as described in FIG. 9 above. In an embodiment, STA 910 may be an AP STA and STA 920 may be a non-AP STA, or vice versa. In another embodiment, STAs 910 and 920 both may be AP STAs or non-AP STAs. STAs 910 and 920 may communicate directly.

Due to unreliable communication or to extend the range of existing communication, STA 910 may use relay 930 to communicate with STA 920. As such, STA 910 may transmit data frames destined to STA 920 via relay 930. STA 910 and/or relay 930 may choose to protect the transmitted data frames with TXOP protection while relaying the data frames via relay 930. In another embodiment, STA 910 and/or relay 930 may choose not to protect the data frames with TXOP protection while relaying the data frames via relay 930.

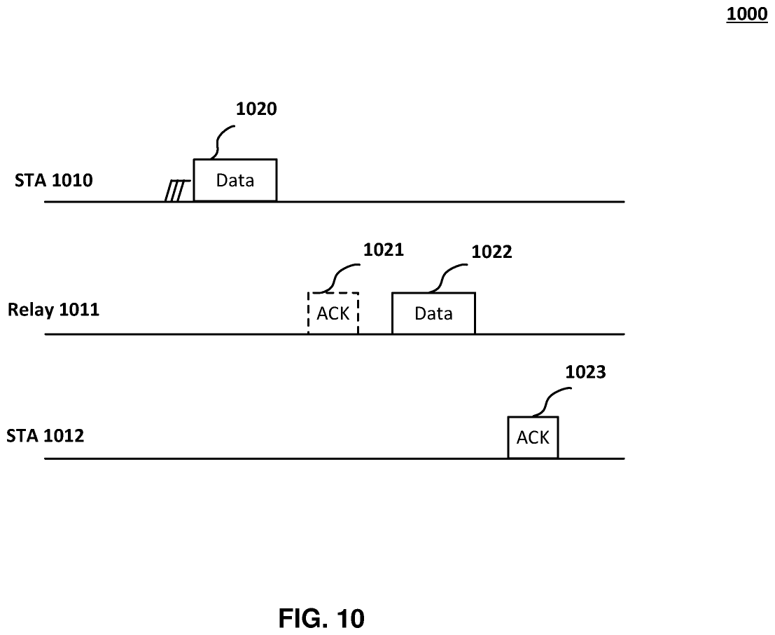

FIG. 10 is an example 1000 that illustrates relaying with no transmission opportunity (TXOP) protection. Example 1000 may be an example according to the TXOP sharing procedures for S1G relay operation as defined in section 10.54.5 of the IEEE 1002.11 standard draft “IEEE P 802.11-REVme™/D2.1, January 2023.” As shown in FIG. 10, example 1000 may include STAs 1010 and 1012 and relay 1011.

In example 1000, STA 1010 may be a STA that supports TXOP sharing procedures. As shown in FIG. 10, STA 1010 may transmit a data frame 1020 destined to STA 1012 via relay 1011. Data frame 1020 may be a protocol version 1 (PV1) QoS data frame. In an implementation, STA 1010 may set a Relayed Frame field in a Frame Control field of data frame 1020 to 1. The Relayed Frame field set to 1 indicates a relay-shared TXOP. On receiving data frame 1020 with the Relay Frame field set to 1, relay 1011 may transmit an ACK frame 1021 if an explicit ACK procedure is used. Alternatively, relay 1011 may not transmit an ACK frame if an implicit ACK procedure is used.

In example 1000, relay 1011 may transmit data frame 1022 to STA 1012 without protecting data frame 1022. STA 1012 may transmit an ACK frame 1023 after receiving data frame 1022 from relay 1011. Relaying without TXOP protection may allow a lower latency transmission of data frame 1020 from STA 1010 to STA 1012. However, communication may be less reliable in case that other STAs of the same BSS may be present within the communication ranges of STAs 1010, 1012 and relay 1011. To improve communication reliability, an RTS/CTS procedure may be used to protect relayed data frames as further described below.

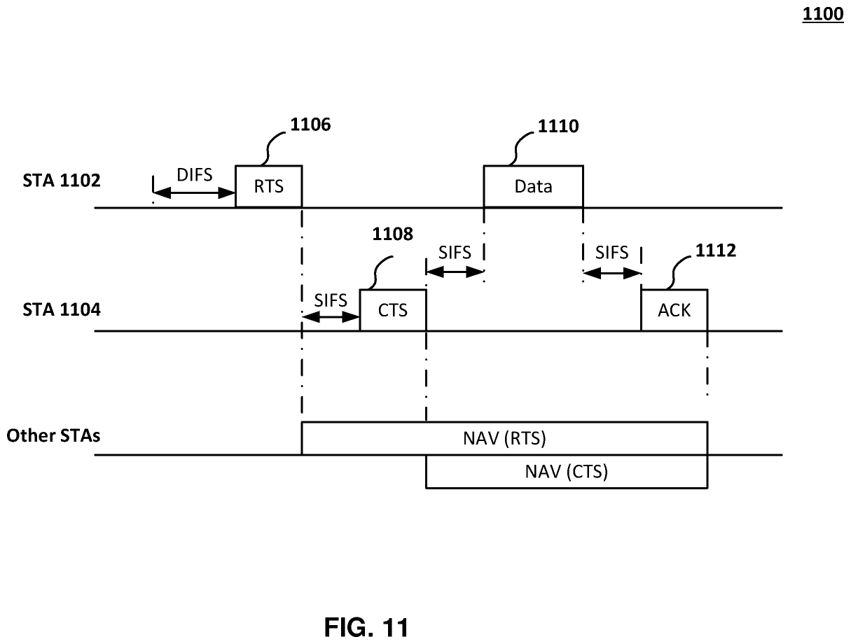

FIG. 11 illustrates an example 1100 of a Request-to-Send (RTS)/Clear-to-Send (CTS) procedure. Example 1100 may illustrate the RTS/CTS procedure as defined in section 10.3.2.9 of the IEEE 802.11 standard draft “IEEE P802.11-REVme™/D2.1, January 2023.” As shown in FIG. 11, example 1100 may include STAs 1102 and 1104. Other STAs of the same BSS may also be within communication range of STAs 1102 and 1104.

In an example, STA 1102 may transmit an RTS frame 1106 to STA 1104. STA 1102 may transmit RTS frame 1106 to protect from hidden STA(s) the transmission of a data frame 1110 that STA 1102 intends to transmit. RTS frame 1106 may include a Duration/ID field. The Duration/ID field may be set to the time, in microseconds, required to transmit data frame 1110, plus one CTS frame, plus one ACK frame (if required), plus three SIFS (Short Interframe Spacing) periods.

In an example, STA 1104 may respond to RTS frame 1106 by transmitting a CTS frame 1108 to STA 1102. CTS frame 1108 may be transmitted one SIFS period after RTS frame 1106. STA 1104 may respond to RTS frame 1106 when RTS frame 1106 is addressed to STA 1104 and after considering the NAV, unless the NAV was set by a frame originating from STA 1102. STA 1104 may respond to the RTS frame 1106 when RTS frame 1106 is addressed to STA 1104 and if the NAV indicates idle. For a non-S1G STA, the NAV indicates idle when the NAV count is 0 or when the NAV count is non-zero but a nonbandwidth signaling TA obtained from a TA field of RTS frame 1106 matches a saved TXOP holder address. For an S1G STA, the NAV indicates idle when both the NAV and RID (response indication deferral) counters are 0 or when either the NAV or RID counter is non-zero but the TA field of RTS frame 1106 matches the saved TXOP holder address.

STA 1104 may set an RA field of CTS frame 1108 to a nonbandwidth signaling TA obtained from the TA field of RTS frame 1106. STA 1104 may set a Duration field of CTS frame 1108 based on the Duration/ID field of RTS frame 1106, namely as equal to the value of the Duration/ID field of RTS frame 1106, adjusted by subtracting the time required to transmit CTS frame 1108 and one SIFS period.

Upon receiving CTS frame 1108, STA 1102 may wait one SIFS period before transmitting data frame 1110. STA 1104 may transmit an ACK frame 1112 in response to data frame 1110. STA 1104 may transmit ACK frame 1112 one SIFS after receiving data frame 1110.

As shown in example 1100, other STAs within communication range of STAs 1102 and 1104, and belonging to the same BSS, may set their NAVs according to RTS frame 1106 and/or CTS frame 1108. For example, a STA receiving RTS frame 1106 may set its NAV based on the Duration/ID field of RTS frame 1106. Another STA receiving CTS frame 1108 may set its NAV based on the Duration field of CTS frame 1108. As such, the other STAs may not access the channel using EDCA until the end of transmission of ACK frame 1112.

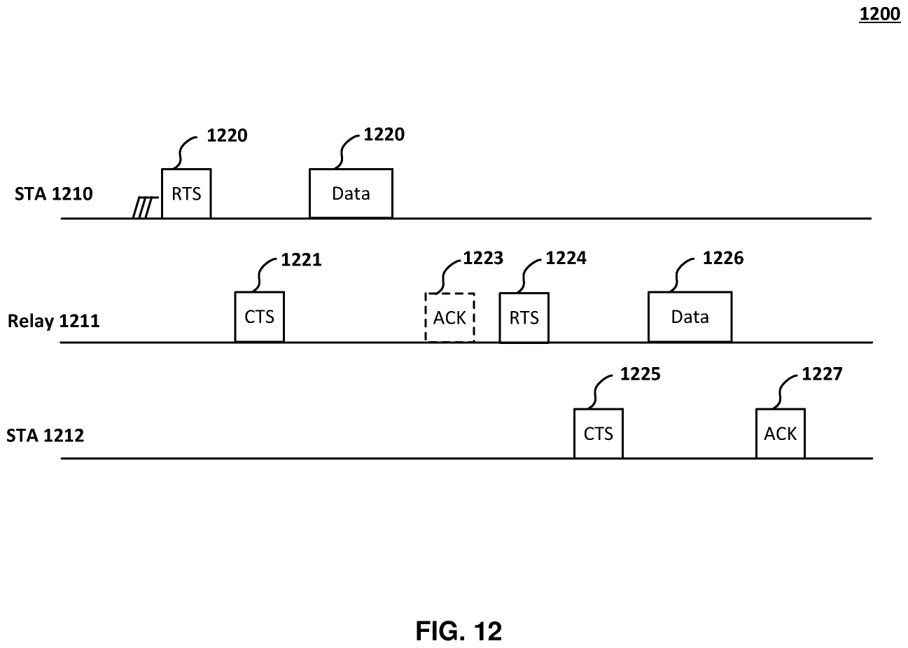

FIG. 12 is an example 1200 that illustrates relaying with TXOP protection. Example 1200 may be an example according to the TXOP sharing procedures for S1G relay operation as defined in section 12.54.5 of the IEEE 802.11 standard draft “IEEE P802.11-REVme™/D2.1, January 2023.” As shown in FIG. 12, example 1200 may include STAs 1210 and 1212 and relay 1211.

In an example, STA 1210 may be a STA that supports TXOP sharing procedures. Before transmitting a data frame 1222 to relay 1211, STA 1210 may transmit an RTS frame 1220 to relay 1211. Relay 1211 may respond to RTS frame 1220 by transmitting a CTS frame 1221 to STA 1210, if its NAV indicates idle. Upon receiving CTS frame 1221, STA 1210 may transmit data frame 1222 to relay 1211. Relay 1211 may transmit an ACK frame 1223 if an explicit ACK procedure is used. Alternatively, relay 1211 may not transmit an ACK frame if an implicit ACK procedure is used.

Similarly, before relaying receive data frame 1222 onto STA 1212, relay 1211 may transmit an RTS frame 1224 to STA 1212. STA 1212 may respond to RTS frame 1224 by transmitting a CTS frame 1225 to relay 1211, if its NAV indicates idle. Upon receiving CTS frame 1225, relay 1211 may transmit a data frame 1226 (relay of data frame 1222) to STA 1212. STA 1212 may transmit an ACK frame 1227 to relay 1211 after receiving data frame 1226.

Relaying with TXOP protection provides a more reliable approach to transmit data frames from a source STA to a destination STA. This may be achieved by using the RTS/CTS procedure sequentially in source-to-relay and relay-to-destination links. However, where the relay-to-destination link is not available due to a busy medium, there may be a delay until the relay receives a CTS frame from the destination STA and can transmit the data frame to the destination STA. An end-to-end approach that provides TXOP protection for both links may thus be more suitable to prevent any such delays.

In the next Wi-Fi standard, a triggered TXOP sharing (TXS) procedure may allow an AP to allocate a portion of the time within an obtained TXOP to a STA for transmitting one or more non-trigger-based (non-TB) PPDUs. For the triggered TXOP sharing procedure, the AP may transmit a multi-user request-to-send (MU-RTS) trigger frame with a triggered TXOP sharing mode subfield set to a non-zero value. The MU-RTS trigger frame is a trigger frame for triggering CTS frame(s) from multiple users.

In an example embodiment, an MU-RTS TXS (triggered TXOP sharing) trigger (MRTT) frame is a MU-RTS trigger frame with a triggered TXOP sharing mode subfield set to a non-zero value (e.g., 1 or 2).

In an example, during the portion of the allocated time, the STA may transmit the one or more non-TB PPDUs to the AP. In this case, a triggered TXOP sharing mode subfield in an MU-RTS TXS trigger frame may be set to 1.

In an example, during the portion of the allocated time, the STA may transmit the one or more non-TB PPDUs to the AP or a peer STA. In an example, the peer STA may be a STA with a connection for peer-to-peer (P2P) communication or direct communication with the STA. In this case, a triggered TXOP sharing mode subfield in an MU-RTS TXS trigger frame may be set to 2. In an example, the direct wireless link is established according to the tunneled direct link setup (TDLS) protocol.

A sounding PPDU is a PPDU transmitted by a transmitting STA to enable a receiving STA to estimate the channel between the transmitting STA and the receiving STA. According to the IEEE 802.11 standard, a sounding PPDU is a PPDU for which the SOUNDING parameter of the corresponding RXVECTOR or TXVECTOR has the value SOUNDING.

In an example, the sounding PPDU comprises a sounding null data PPDU (NDP). The NDP is a PPDU that carries no data field.

In an example, the sounding PPDU may comprise a PPDU carrying on training symbols of channel sounding. The training symbols may be known at a transmitting STA and a receiving STA. The receiving STA may use the training symbols of channel sounding to estimate the channel state information (CSI). The CSI may comprise channel coefficients.

Channel sounding may adopt transmit beamforming with explicit feedback mechanisms, such as explicit feedback beamforming, to allow the transmitting STA to transmit the sounding PPDU to the receiving STA.

Transmit beamforming is a technique in which a transmitting STA utilizes knowledge of a MIMO channel to generate a steering matrix that is applied to the transmitted signal to optimize reception at one or more receiving STAs. The STA transmitting using the steering matrix is called the beamformer (transmitter of the beamformed signal). The STA for which reception is optimized is called a beamformee (receiver of the beamformed signal). Transmit beamforming may be used for sounding a SU MIMO channel or a MU MIMO channel.

In explicit feedback beamforming, the beamformer may apply an orthonormal spatial mapping matrix as the steering matrix to training symbols in the sounding PPDU. By receiving the sounding PPDU over a MIMO channel, the beamformee measures an effective channel using the training symbols. The effective channel is a product of an equivalent complex baseband MIMO channel coefficient matrix and the steering matrix used on transmit. By using an estimate of the equivalent channel, the beamformer may prepare a channel quality indication (CQI) as CSI feedback or a beamforming feedback matrix as beamforming feedback. The beamformee quantizes the feedback and send it to the beamformer. The beamformer may use this feedback to calculate a new steering matrix for a beamformed data transmission.

An extremely high throughput (EHT) sounding protocol may use the explicit feedback beamforming.

EHT STAs may use an EHT sounding protocol to determine CSI. The EHT sounding protocol may provide explicit feedback mechanisms, including an EHT non-trigger-based (non-TB) sounding sequence and an EHT trigger-based (TB) sounding sequence. An EHT beamformee may measure the channel using a training signal (e.g., an EHT sounding NDP) transmitted by an EHT beamformer and send back a transformed estimate of the CSI. The transformed estimate of the CSI comprises the quantized CQI feedback or a quantized beamforming feedback matrix based on the estimate of equivalent channel. The EHT beamformer may use this estimate to derive the steering matrix.

The EHT beamformee may return the estimate of the CSI in an EHT compressed beamforming/CQI report carried in one or more EHT compressed beamforming/CQI frames. There are three types of EHT compressed beamforming/CQI report:
a) SU feedback: The EHT compressed beamforming/CQI report comprises an EHT Compressed Beamforming Report field.
b) MU feedback: The EHT compressed beamforming/CQI report comprises an EHT Compressed Beamforming Report field and EHT MU exclusive beamforming report field.
c) CQI feedback: The EHT compressed beamforming/CQI report comprises an EHT CQI Report field.

The EHT compressed beamforming/CQI report may be carried in a single EHT compressed beamforming/CQI frame if the resulting frame is less than or equal to 11454 octets in length. Otherwise, the EHT beamforming feedback may be segmented and each segment may be carried in an EHT compressed beamforming/CQI frame.

An EHT beamformer shall support a maximum MPDU length for the EHT compressed beamforming/CQI report that is the minimum of 11454 octets and the maximum length of the EHT compressed beamforming/CQI report that the EHT beamformer intends to solicit from its EHT beamformee(s).

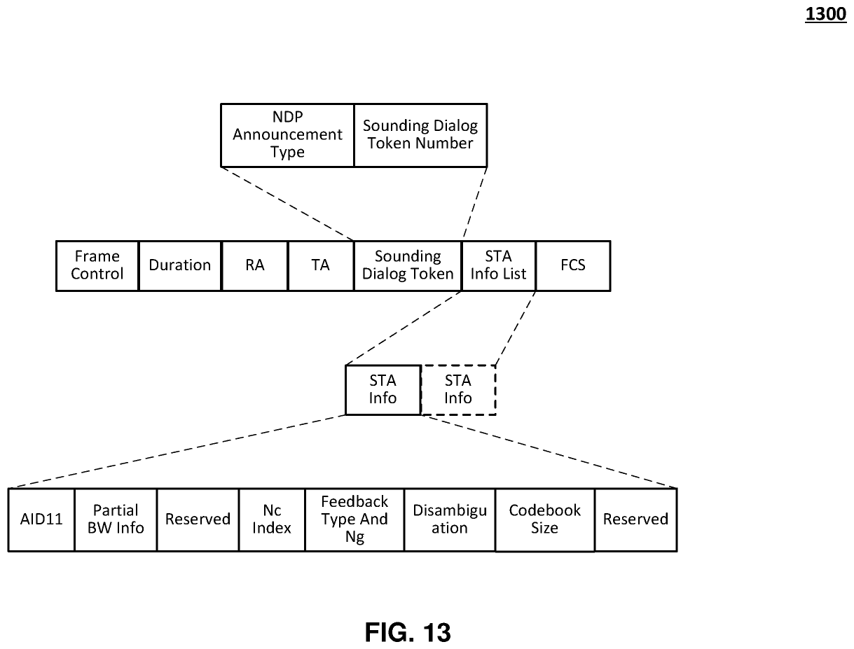

FIG. 13 illustrates an example 1300 null data PPDU (NDP) announcement (NDPA) frame format.

The NDP Announcement frame has four variants, the VHT NDP Announcement frame, the HE NDP Announcement frame, the Ranging NDP Announcement frame, and the EHT NDP Announcement frame. The four formats are distinguished by the setting of the NDP Announcement Variant subfield in the Sounding Dialog Token field.

An NDP Announcement frame contains at most one STA Info field per STA.

The NDP Announcement frame contains at least one STA Info field with AID11, AID12, or AID13 subfield.

If the NDP Announcement frame contains only one STA Info field with a value less than 2008 in the AID11, AID12 or AID13 subfield, then in the case of VHT, HE or EHT NDP Announcement frames the RA field is set to the address of the STA addressed in the only STA Info field of this NDP Announcement frame. In the case of Ranging NDP Announcement frame, the RA address is set to the address of the RSTA or ISTA that is the intended recipient of the frame. If the NDP Announcement frame contains more than one STA Info field with a value less than 2008 in the AID11 subfield, then the RA field is set to the broadcast address.

The TA field is set to the address of the STA transmitting the NDP Announcement frame or the bandwidth signaling TA of the STA transmitting the NDP Announcement frame

The setting of the NDP Announcement Variant subfield in the Sounding Dialog Token field identifies the variant of the NDP Announcement frame.

The Sounding Dialog Token Number subfield in the Sounding Dialog Token field contains a value selected by the beamformer to identify the VHT NDP Announcement frame.

The STA Info List field contains one or more, n, STA Info fields.

In the HE NDP Announcement frame, the Duration, RA, and TA fields are set as in the VHT NDP Announcement frame. The NDP Announcement Variant subfield is set to 2 to identify the frame as an HE NDP Announcement frame. The Sounding Dialog Token Number field in the Sounding Dialog Token field contains a value selected by the beamformer to identify the HE NDP Announcement frame.

In the EHT NDP Announcement frame, the Duration, RA, and TA fields are set as in the VHT NDP Announcement frame. The NDP Announcement Variant subfield is set to 3 to identify the frame as an EHT NDP Announcement frame. The Sounding Dialog Token Number field in the Sounding Dialog Token field contains a value selected by the beamformer to identify the EHT NDP Announcement frame.

The AID11 subfield contains an identifier of a STA expected to process the following EHT sounding NDP and prepare the sounding feedback.

The Partial BW Info subfield includes a Resolution Subfield and a Feedback Bitmap subfield.

The Resolution subfield in the Partial BW Info subfield indicates the resolution bandwidth for each bit in the Feedback Bitmap subfield.

The Feedback Bitmap subfield indicates whether feedback is requested for each resolution bandwidth and is ordered from lowest frequency to highest frequency, followed by zeros. A bit in the Feedback Bitmap subfield set to 1 indicates that feedback is requested for the corresponding frequency with the resolution bandwidth; and so B1 set to 1 indicates a request for feedback for the lowest frequency at the indicated resolution bandwidth.

When the bandwidth of the PPDU carrying the EHT NDP Announcement frame is less than 320 MHz, the Resolution bit B 0 is set to 0 to indicate a resolution of 20 MHz.
When the bandwidth of the PPDU carrying the EHT NDP Announcement frame is equal to 20 MHz, B1 is set to 1 to indicate the request of feedback on the 242-tone RU. B2-B8 are set to 0.
When the bandwidth of the PPDU carrying the EHT NDP Announcement frame is equal to 40 MHz, B1 and B2 indicate the request of feedback on each of the two 242-tone RUs from lower frequency to higher frequency. B3-B8 are set to 0.
When the bandwidth of the PPDU carrying the EHT NDP Announcement frame is equal to 80 MHz, if B1-B4 are all set to 1, it indicates the feedback request on the 996-tone RU, otherwise, B1-B4 indicate the request of feedback on each of the four 242-tone RUs from lower frequency to higher frequency. B5-B8 are set to 0.
When the bandwidth of the PPDU carrying the EHT NDP Announcement frame is equal to 160 MHz, if B1-B4 are all set to 1, it indicates the feedback request on the lower 996-tone RU, otherwise, B1-B4 indicate the request of feedback on each of four 242-tone RUs from lower frequency to higher frequency in the lower 80 MHz. If B5-B8 are all set to 1, it indicates the feedback request on the upper 996-tone RU, otherwise, B5-B8 indicate the request of feedback on each of the four 242-tone RUs from lower frequency to higher frequency in the upper 80 MHz.

When the bandwidth of the PPDU carrying the EHT NDP Announcement frame is equal to 320 MHz, the Resolution subfield (B0) is set to 1 to indicate a resolution of 40 MHz. If B1 and B2 are both set to 1, it indicates the feedback request on the lowest 996-tone RU, otherwise, B1 and B2 indicate the request of feedback on each of the two 484-tone RUs from lower frequency to higher frequency in the lowest 80 MHz. If B3 and B4 are both set to 1, it indicates the feedback request on the second lowest 996-tone RU, otherwise, B3 and B4 indicate the request of feedback on each of the two 484-tone RUs from lower frequency to higher frequency in the second lowest 80 MHz. If B5 and B6 are both set to 1, it indicates the feedback request on the third lowest 996-tone RU, otherwise, B5 and B6 indicate the request of feedback on each of the two 484-tone RUs from lower frequency to higher frequency in the third lowest 80 MHz. If B7 and B8 are both set to 1, it indicates the feedback request on the highest 996-tone RU, otherwise, B7 and B8 indicate the request of feedback on each of the two 484-tone RUs from lower frequency to higher frequency in the highest 80 MHz. The feedback tone sets for each 484-tone RU is composed of the feedback tone sets of the two 242-tone RUs overlapping with the 484-tone RU.

The Feedback Type And Ng and Codebook Size subfields for EHT TB sounding are the same as for HE TB sounding. The Feedback Type And Ng and Codebook Size subfields for EHT non-TB sounding are the same as for HE non-TB sounding.

In an EHT NDP Announcement frame with more than one STA Info field that contains a value less than 2008 in the AID11 subfield, the RA is a broadcast address and the following applies:
If the Feedback Type And Ng subfield and the Codebook Size subfield indicate SU or MU, the Nc Index subfield indicates the number of columns in the compressed beamforming feedback matrix minus 1, Nc−1. Nc Index subfield values above 7 are reserved.
If the Feedback Type And Ng subfield and the Codebook Size subfield indicate CQI, the Nc Index subfield indicates the number of spatial streams in the CQI report minus 1, Nc−1. Nc Index subfield values above 7 are reserved.

In an EHT NDP Announcement frame with a single STA Info field that contains a value less than 2008 in the AID11 subfield, the RA is an individual address and the Nc index subfield is reserved.

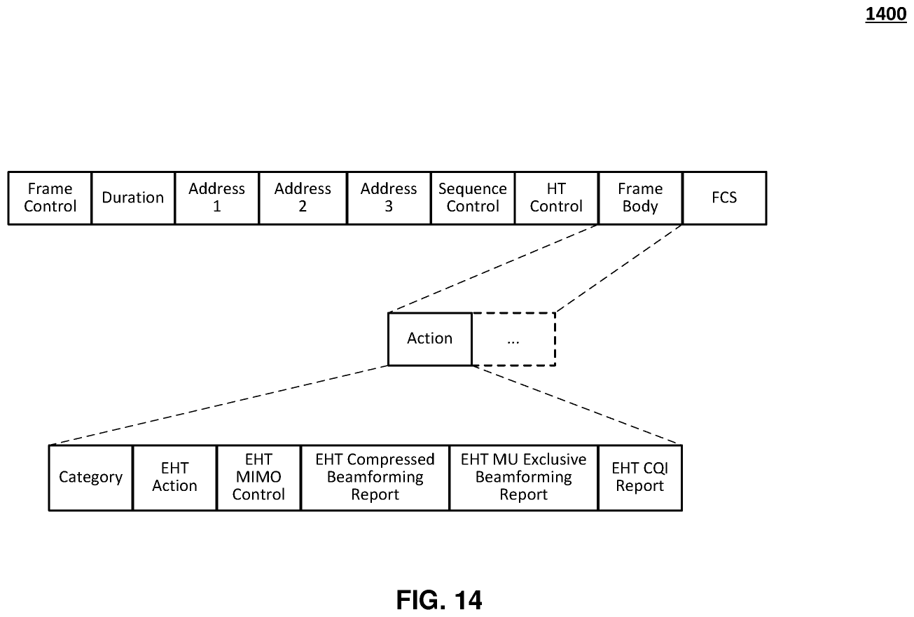

FIG. 14 illustrates an example EHT compressed beamforming/CQI frame 1400. EHT Compressed Beamforming/CQI frame 1400 may be an Action No Ack frame of category EHT. The Action field of an EHT Compressed Beamforming/CQI frame contains the information including a Category field, an EHT Action field, an EHT MIMO Control field, an EHT Compressed Beamforming Report field, an EHT MU Exclusive Beamforming Report field, an EHT CQI Report.

The Category field is set to a value of 36 for EHT category.

The EHT Action field, in the octet immediately after the Category field, differentiates the EHT Action frame formats. The EHT Action field values associated with each frame format within the EHT category. The EHT Action field is set to a value of 0 for EHT Compressed Beamforming/CQI.

The EHT MIMO Control field comprises a Nc Index subfield, a Nr Index subfield, a BW subfield, a Grouping subfield, a Codebook Information subfield, a Feedback Type subfield, a Remaining Feedback Segments subfield, a First Feedback Segment subfield, a Partial BW Info subfield, a Sounding Dialog Token Number subfield.

In an EHT Compressed Beamforming/CQI frame not carrying all or part of an EHT compressed beamforming/CQI report, the Nc Index, Nr Index, BW, Grouping, Codebook Information, Feedback Type, and Sounding Dialog Token Number subfields are reserved, the First Feedback Segment subfield is set to 0, and the Remaining Feedback Segments subfield is set to 7.

The EHT Compressed Beamforming Report field carries the average SNR of each spatial stream and compressed beamforming feedback matrices for use by a transmit beamformer to determine steering matrices for explicit feedback beamforming.

The EHT MU Exclusive Beamforming Report field carries explicit feedback in the form of delta SNRs. The information in the EHT Compressed Beamforming Report field and the EHT MU Exclusive Beamforming Report field can be used by the transmit MU beamformer to determine the steering matrices for DL MU-MIMO.

The EHT CQI Report field carries the per-RU average SNRs of each spatial stream, where each per-RU average SNR is the arithmetic mean of the SNR in decibels over the subcarriers of a 26-tone RU for which feedback is being requested.

The EHT CQI Report field contains EHT CQI report information. EHT CQI Report information is included in the EHT compressed beamforming/CQI report if the Feedback Type subfield in the EHT MIMO Control field indicates CQI feedback.

The presence and contents of the EHT Compressed Beamforming Report field, EHT MU Exclusive Beamforming Report field, and EHT CQI Report field are dependent on the values of the Feedback Type subfield of the EHT MIMO Control field.

A Vendor Specific element is not present in the EHT Compressed Beamforming/CQI frame.

An EHT non-TB sounding sequence may be initiated by an EHT beamformer with an individually addressed EHT NDP announcement frame comprising exactly one STA Info field, followed after SIFS by an EHT sounding NDP. The EHT beamformee may respond after SIFS with an EHT compressed beamforming/CQI frame.

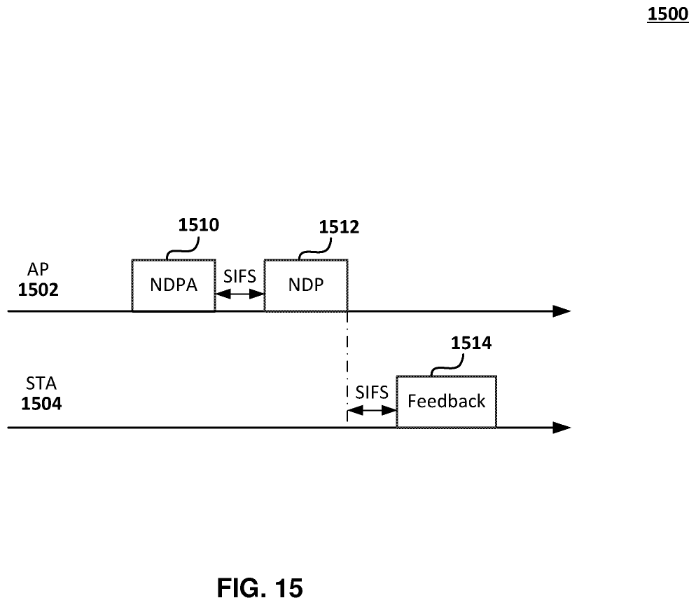

FIG. 15 illustrates an example 1500 EHT non trigger based (non-TB) sounding sequence. As shown in FIG. 15, example 1500 includes an AP 1502 and a STA 1504. Example 1600 may begin with AP 1502 initiating the EHT non-TB sounding sequence by transmitting an NDPA frame 1510 (e.g. EHT NDP announcement frame). AP 1502 may initiate the EHT non-TB sounding sequence to solicit SU feedback, or CQI feedback from STA 1604.

In an example, SU feedback may comprise a compressed beamforming report. In an example, the compressed beamforming report may comprise average SNR of each spatial stream and compressed beamforming feedback matrices for use by a transmit beamformer to determine steering matrices for explicit feedback beamforming.

In an example, CQI feedback may comprise CQI report. In an example, the CQI report may comprise per-RU average SNRs of each spatial stream. In an implementation, each per-RU average SNR may comprise an arithmetic mean of the SNR in decibels over the subcarriers of a 26-tone RU for which feedback is being requested.

AP 1502 may be an EHT beamformer. NDPA frame 1510 may include a single STA Info field. The AID11 subfield of the STA Info field may be set to the AID of the STA (e.g. STA 1504) identified by the RA field or to 0 if the STA identified by the RA field is an associated AP, mesh STA or IBSS STA. NDPA frame 1510 may be followed after a SIFS by an NDPA frame 1512 (e.g. EHT sounding NDP), which may be followed after a SIFS by feedback frame 1514 carried in a PPDU containing one or more EHT compressed beamforming/CQI frames.

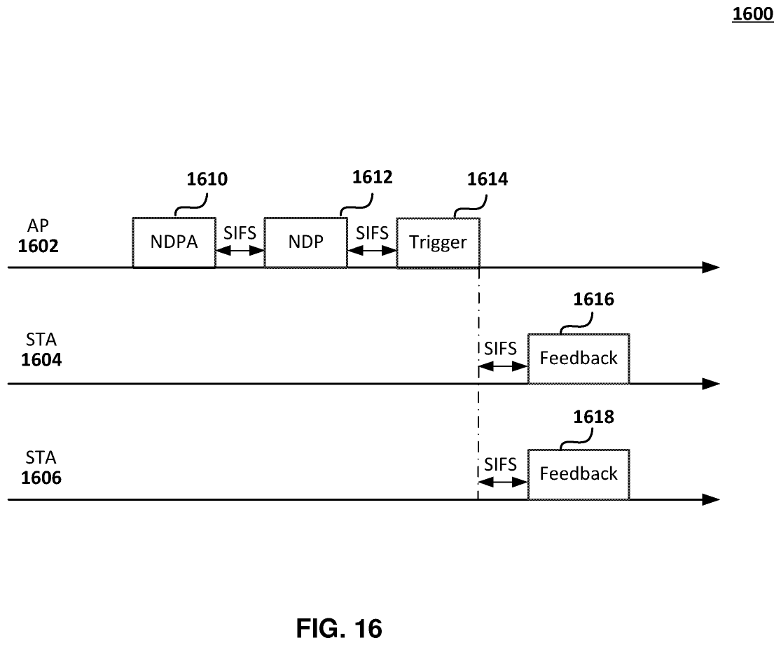

FIG. 16 illustrates an example 1600 of an EHT trigger based (TB) sounding sequence. As shown in FIG. 16, example 1600 includes an AP 1602 and STAs 1604 and 1606. Example 1600 may begin with AP 1602 initiating the EHT TB sounding sequence by transmitting an NDPA frame 1610. AP 1602 may initiate the EHT TB sounding sequence to solicit SU feedback, MU feedback, or CQI feedback from STAs 1604 and 1606.

In an example, SU feedback may comprise a compressed beamforming report. In an example, the compressed beamforming report may comprise average SNR of each spatial stream and compressed beamforming feedback matrices for use by a transmit beamformer to determine steering matrices for explicit feedback beamforming.

In an example, MU feedback may comprise the compressed beamforming report and a MU exclusive beamforming report. In an example, the MU exclusive beamforming report may comprise explicit feedback in the form of delta SNRs.

In an example, CQI feedback may comprise CQI report. In an example, the CQI report may comprise per-RU average SNRs of each spatial stream. In an implementation, each per-RU average SNR may comprise an arithmetic mean of the SNR in decibels over the subcarriers of a 26-tone RU for which feedback is being requested.

AP 1602 may be an EHT beamformer. NDPA frame 1610 may include two or more STA Info fields and the RA field set to the broadcast address. A SIFS after NDPA frame 1610, AP 1602 may transmit an NDP frame 1612, followed by a trigger (e.g., beamforming report poll (BFRP) trigger) frame 1614, a SIFS after NDP frame 1612. Trigger frame 1614 may address STAs 1604 and 1606 as EHT beamformees. In response, STAs 1604 and 1606 may respond a SIFS after trigger frame 1614 with respective feedback frames 1616 and 1618. Feedback frames 1616 and 1618 may each be carried in an EHT TB PPDU and may comprise one or more EHT compressed beamforming/CQI frames.

AP 1602 may send additional trigger frame(s) in the same TXOP to solicit feedback frames from EHT beamformees not addressed in trigger frame 1614. AP 1602 may not transmit a trigger frame that solicits a STA identified in NDPA frame 1610 unless the trigger frame is in the same TXOP as NDPA frame 1610.

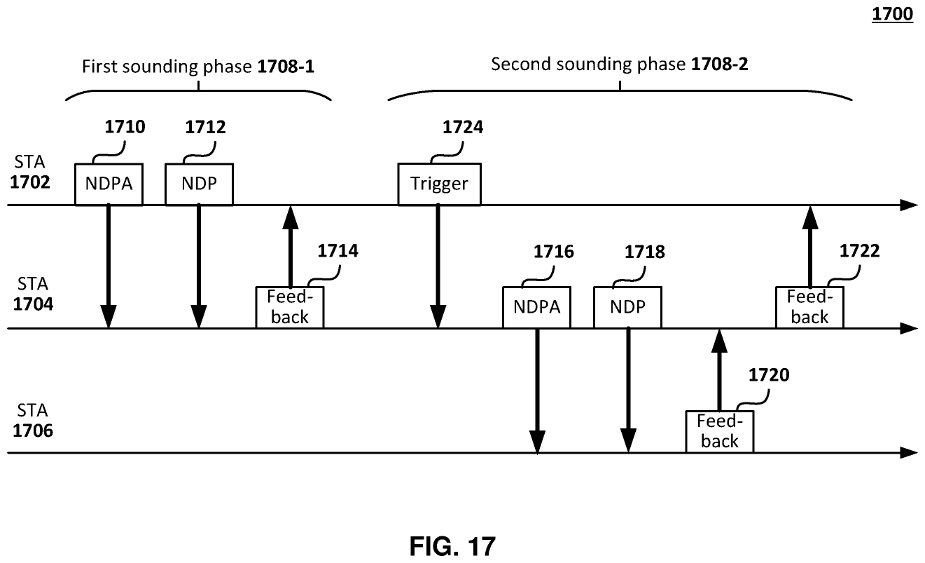

FIG. 17 illustrates an example 1700 of a sounding procedure for relay communication. Example 1700 may be an example of an EHT non-TB sounding sequence. As shown in FIG. 17, example 1700 may include STAs 1702, 1704 and 1706. In an example, STA 1702 and STA 1704 may within each other's communication ranges, STA 1702 and STA 1706 may be outside of each other's communication ranges, and STA 1704 and STA 1706 may be within each other's communication ranges. In an example, STA 1702 may comprise an AP. In an example, STA 1704 may comprise a relay. In an example, the relay may comprise a relay AP and a relay STA. In an example, STA 1704 may comprise a mobile relay. In an example, STA 1706 may comprise a non-AP STA.

In an example, STA 1702 may support EHT non-TB sounding as an EHT beamformer. In an example, STA 1704 may be support EHT non-TB sounding as a beamformer and as a beamformee. In an example, STA 1706 may be support non-TB sounding as a beamformee.

As shown in FIG. 17, example 1700 may comprise a first sounding phase 1708-1 and a second sounding phase 1708-2. First sounding phase 1708-1 may comprise a first sounding sequence to estimate a first channel from STA 1702 to STA 1704. Second sounding phase 1708-2 may comprise a second sounding sequence to estimate a second channel from STA 1704 to STA 1706. In an example, the first sounding sequence or the second sounding sequence may comprise an EHT non-TB sounding sequence. In an example, second sounding phase 1708-2 may comprise reporting feedback of the second sounding sequence from STA 1704 to STA 1702.

As shown in FIG. 17, first sounding phase 1708-1 may begin with STA 1702 transmitting an NDPA frame 1710 to STA 1704. In an example, NDPA frame 1710 may comprise an EHT NDPA frame. NDPA frame 1710 may announce an NDP 1712 to be transmitted by STA 1702 for estimating the first channel by STA 1704. In an example, NDP 1712 may comprise a EHT sounding NDP. In an example, NDPA frame 1710 may solicit SU feedback or CQI feedback from STA 1704. A SIFS after transmitting NDPA frame 1710, STA 1702 transmits NDP 1712 to STA 1704. A SIFS after receiving NDP 1712, STA 1704 transmits to STA 1702 a feedback frame 1714 based on NDP 1712. In an example, feedback frame 1714 may comprise a EHT compressed beamforming/CQI frame including SU feedback or CQI feedback of the first channel.

As shown in FIG. 17, second sounding phase 1708-2 may begin with STA 1702 transmitting to STA 1704 a trigger frame 1724 that triggers STA 1704 to start the second sounding sequence for estimating the second channel. In an example, after receiving trigger frame 1724, STA 1704 may transmit to STA 1706 a NDPA frame 1716. In an example, NDPA frame 1716 may comprise an EHT NDPA frame. NDPA frame 1716 may announce an NDP 1718 to be transmitted by STA 1704 for estimating the second channel by STA 1706. In an example, NDP 1718 may comprise an EHT sounding NDP. In an example, NDPA frame 1716 may solicit SU feedback or CQI feedback from STA 1706. A SIFS after transmitting NDPA frame 1716, STA 1704 transmits to STA 1706 NDP 1718. A SIFS after receiving NDP 1718, STA 1706 transmits feedback frame 1720 based on NDP 1718. In an example, feedback frame 1720 may comprise a EHT compressed beamforming/CQI frame including SU feedback or CQI feedback of the second channel. As shown in FIG. 17, after receiving feedback frame 1720, STA 1704 may transmit a feedback frame 1722 reporting the feedback of the second channel. In an example, feedback frame 1722 may comprise the EHT compressed beamforming/CQI frame received in feedback frame 1720. In an example, feedback frame 1722 may comprise SU feedback or CQI feedback of the second channel.

Generally, the relay sounding procedure is repeated whenever the first channel and/or the second channel changes. For example, as mentioned above, STA 1704 may comprise a mobile relay, which upon moving causes both the first channel and the second channel to change. Upon detecting the change, the relay sounding procedure may be repeated to estimate the first channel and the second channel again. With the relay sounding procedure of FIG. 17 requiring two separate sounding sequences to estimate the first channel and the second channel, the overhead for performing relay sounding may become excessive particularly with frequent changes of the first and the second channel. For example, with each change of the first and/or second channel, the sounding procedure of FIG. 17 requires the transmission of at least two NDPA frames, at least three feedback frames, and a trigger frame. This lengthy relay procedure may also increase the latency of the data being transmitted between STA 1702 and STA 1706.

Embodiments of the present disclosure, as further described below, address the above-described problems of existing sounding procedures for relaying.

In a one aspect, a first STA may receive from a second STA a first frame indicating or announcing a first physical layer protocol data unit (PPDU) to be transmitted by the second STA; and indicating or triggering the first STA to transmit to a third STA a second frame, the second frame indicating or announcing a second PPDU to be transmitted by the first STA to the third STA. The first STA may be a relay STA, the second STA may be a source STA, and the third STA may be a destination STA. The first PPDU may be for estimation, by the first STA, of a first channel from the second STA to the first STA. The second PPDU may be for estimation, by the third STA, of a second channel from the first STA to the third STA. As such, the first frame may trigger simultaneously the estimation of both the first channel and the second channel.

In another aspect, a first STA may receive a first PPDU for estimation, by the first STA, of a of a first channel from the second STA to the first STA. The first STA may transmit to a third STA a second PPDU for estimation, by the third STA, of a second channel from the first STA to the third STA. The first STA may receive from the third STA a first frame comprising a first estimate of the second channel, and may transmit to the second STA a second frame comprising: a second estimate of the first channel; and the first estimate of the second channel. The first STA may thus convey to the second STA estimates of the first and second channels in a single overhead.

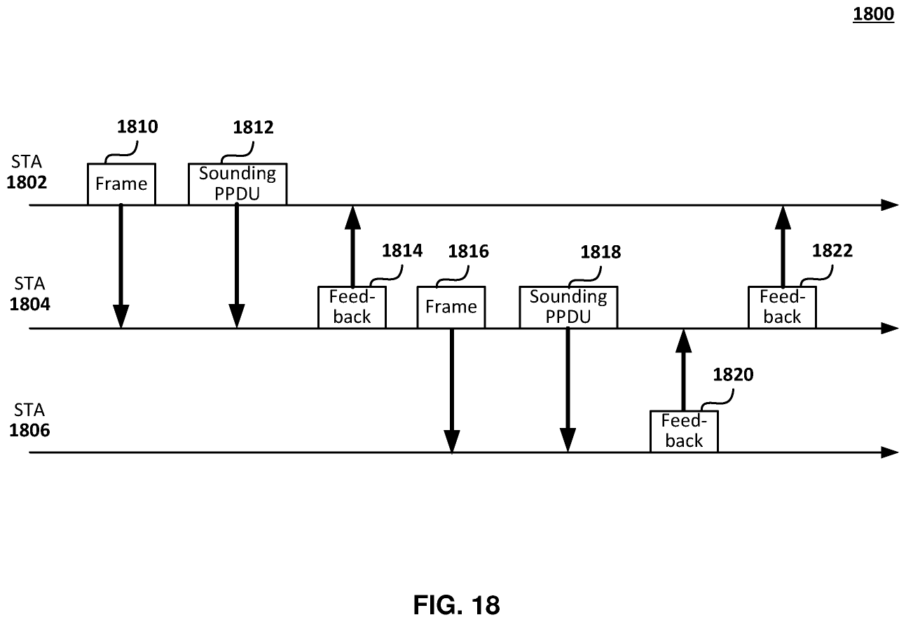

FIG. 18 is an example that illustrates a sounding procedure for relay communication according to an embodiment. Example 1800 is provided for the purpose of illustration only and is not limiting.

As shown in FIG. 18, example 1800 may include STAs 1802, 1804 and 1806. In an example, STAs 1804 and 1806 may be associated with STA 1802. STAs 1802, 1804, and/or 1806 may each comprise a multi-link device (MLD).

In an example, STA 1802 and STA 1804 may be within each other's communication ranges, STA 1802 and STA 1806 may be outside of each other's communication ranges, and, STA 1804 and STA 1806 may be within each other's communication ranges. In an example, STA 1802 may comprise an AP. In an example, STA 1802 may comprise a relay. In an example, the relay may comprise a relay AP and a relay STA. In an example, STA 1804 may comprise a mobile relay. In an example, STA 1806 may comprise a non-AP STA.

It is assumed in example 1800 that STA 1802 supports a relay sounding capability. In an example, support of the relay sounding capability allows STA 1802 to transmit a first frame (such as frame 1810 described below) indicating or announcing a first PPDU (such as a PPDU 1812 described below) to be transmitted by STA 1802; and indicating or triggering a second STA (such as STA 1804) to transmit to a third STA (such as STA 1806) a second frame (such as a frame 1816 described below) indicating or announcing a second PPDU (such as a PPDU 1818 described below) to be transmitted by the second STA to the third STA. In an embodiment, STA 1802 may comprise a beamformer. In an example, support of the relay sounding capability allows STA 1802 to transmit the first PPDU for estimation of a first channel from STA 1802 to the second STA after transmitting the first frame. In an example, support of the relay sounding capability allows STA 1802 to receive frames (such as frames 1814 and 1822 described below) from the second STA.

It is assumed in example 1800 that STA 1804 supports a relay sounding capability. In an example, support of the relay sounding capability allows STA 1804 to receive a first frame (such as frame 1810 described below) indicating or announcing a first PPDU (such as PPDU 1812 described below) to be transmitted by a second STA (such as STA 1802); and indicating or triggering STA 1804 to transmit to a third STA (such as STA 1806) a second frame (such as frame 1816 described below) indicating or announcing a second PPDU (such as PPDU 1818 described below) to be transmitted by STA 1804 to a third STA. In an embodiment, STA 1804 may comprise a beamformee. In an example, support of the relay sounding capability allows STA 1804 to transmit frames/PPDUs (such as frame 1816 and PPDU 1818 described below) to the second STA. In an embodiment, STA 1804 may comprise a beamformer. In an example, support of the relay sounding capability allows STA 1804 to transmit frames/PPDUs (such as frame 1816 and PPDU 1818 described below) to the third STA. In an example, support of the relay sounding capability allows STA 1804 to receive the first PPDU for estimation of a first channel from the second STA to STA 1804 after receiving the first frame. In an example, support of the relay sounding capability allows STA 1804 to transmit the second PPDU for estimation of a second channel from STA 1804 to the third STA after transmitting the second frame.

In an embodiment, prior to the beginning of example 1800, STAs 1802 and 1804 may exchange a first frame and a second frame (not shown in FIG. 18) to exchange capability information. In an embodiment, the first frame may comprise the capability information of STA 1802, including a first indication of support by STA 1802 of the relay sounding capability. In an embodiment, the second frame may comprise the capability information of STA 1804, including a second indication of support by STA 1804 of the relay sounding capability. In an embodiment, the first frame and the second frame may be exchanged after association between STA 1802 and 1804. In an embodiment, the first frame and the second frame may comprise a management frame.

As shown in FIG. 18, example 1800 may begin with STA 1802 transmitting to STA 1804 a frame 1810 to initiate a sounding sequence. In an example, the sounding sequence may comprise estimating a first channel from STA 1802 to STA 1804 and a second channel from STA 1804 to a STA 1806. In an example, the sounding sequence may comprise sounding for relaying communication. In an example, the sounding sequence may comprise reporting to STA 1802 feedback of the first/second channel.

In an embodiment, frame 1810 may indicate or announce a PPDU 1812 to be transmitted by STA 1802 to STA 1804. In an embodiment, frame 1810 may further indicate or trigger STA 1804 to transmit to STA 1806 a frame 1816. In an embodiment, frame 1816 may indicate or announce a PPDU 1818 to be transmitted by STA 1804 to STA 1806. In an embodiment, PPDU 1812 or 1818 may comprise a sounding PPDU. In an example, PPDU 1812 or 1818 may comprise an NDP.

In an embodiment, frame 1810 may solicit a frame 1814 and/or a frame 1822 from STA 1804. In an embodiment, frame 1816 may solicit a frame 1820 from STA 1806. In an example, frame 1810 may indicate a first feedback type for use by frame 1814 and/or a second feedback type for use by frames 1820 and/or 1822. In an example, the first feedback type or the second feedback type may indicate SU feedback, MU feedback, or CQI feedback. In an example, the second feedback type may be the same as the first feedback type. In another example, the second feedback type may be different from the first feedback type.

In an embodiment, SU feedback may comprise a compressed beamforming report. In an example, the compressed beamforming report may comprise average SNR of each spatial stream and compressed beamforming feedback matrices for use by a transmit beamformer to determine steering matrices for explicit feedback beamforming. In an embodiment, MU feedback comprises the compressed beamforming report and a MU exclusive beamforming report. In an example, the MU exclusive beamforming report may comprise explicit feedback in the form of delta SNRs. In an embodiment, CQI feedback may comprise CQI report. In an example, the CQI report may comprise per-RU average SNRs of each spatial stream. In an implementation, each per-RU average SNR may comprise an arithmetic mean of the SNR in decibels over the subcarriers of a 26-tone RU for which feedback is being requested.

In an embodiment, frame 1810 may comprise a control frame. In an example, the control frame may comprise an announcement frame. In an example, the announcement frame may comprise a NDP announcement (NDPA) frame. In an example, the NDPA frame may comprise an ultra-high reliability (UHR) NDPA frame.

After transmitting frame 1810, STA 1802 may transmit PPDU 1812 to STA 1804. In an embodiment, STA 1802 may transmit PPDU 1812 to STA 1804 a SIFS after transmitting frame 1810. In an embodiment, PPDU 1812 may be for estimation, by STA 1804, of a first channel from STA 1802 to STA 1804.

After receiving PPDU 1812, STA 1804 may transmit to STA 1802 frame 1814. In an embodiment, frame 1814 may indicate a first estimate of the first channel. In an embodiment, the first estimate may comprise first feedback based on PPDU 1812. In an example, the first feedback may comprise SU feedback or CQI feedback based on the first feedback type as indicated in frame 1810. In an embodiment, frame 1814 may comprise a management frame. In an example, the management frame may comprise an action frame. In an example, frame 1814 may comprise a compressed beamforming report or a CQI report.

After transmitting frame 1814 to STA 1802, STA 1804 may transmit frame 1816 to STA 1806. In an embodiment, STA 1804 may transmit frame 1816 to STA 1806 a SIFS after transmitting frame 1814. In another embodiment, STA 1804 may transmit frame 1816 before transmitting frame 1814. In an example, frame 1816 may solicit frame 1820 from STA 1806. In an example, frame 1816 may indicate the second feedback type for use by frame 1820 based on an indication in frame 1810. In an embodiment, frame 1816 may comprise a control frame. In an example, the control frame may comprise an announcement frame. In an example, the announcement frame may comprise a NDP announcement (NDPA) frame. In an example, the NDPA frame may comprise an ultra-high reliability (UHR) NDPA frame.

After transmitting frame 1816, STA 1804 may transmit PPDU 1818 to STA 1806. In an embodiment, STA 1804 may transmit PPDU 1818 a SIFS after transmitting frame 1816. In an embodiment, PPDU 1818 may be for estimation, by STA 1806, of a second channel from STA 1804 to STA 1806.

After receiving PPDU 1818, STA 1806 may transmit frame 1820 to STA 1804. In an embodiment, STA 1806 may transmit frame 1820 a SIFS after receiving PPDU 1818. In an embodiment, frame 1820 may indicate a second estimate of the second channel. In an example, the second estimate may comprise second feedback based on PPDU 1818. In an example, the second feedback may comprise SU feedback or CQI feedback based on the second feedback type as indicated in frame 1816.

After receiving frame 1820, STA 1804 may transmit frame 1822 to STA 1802. Frame 1822 may be in response to frame 1810. In an embodiment, frame 1822 may comprise the second estimate of the second channel indicated in frame 1820. In an embodiment, frame 1822 may be for reporting the second feedback to STA 1802.

In an embodiment, frames 1820 and/or 1822 may comprise a management frame. In an example, the management frame may comprise an action frame. In an example, the action frame may comprise a compressed beamforming report or a CQI report.

As shown in FIG. 18, in accordance with an embodiment, sounding of the end-to-end relay link between STA 1802 and 1806 may be achieved using a single sounding sequence. This may greatly reduce the overhead required for sounding as well as the latency for the relayed data, particularly when the first and/or second channel change frequently.

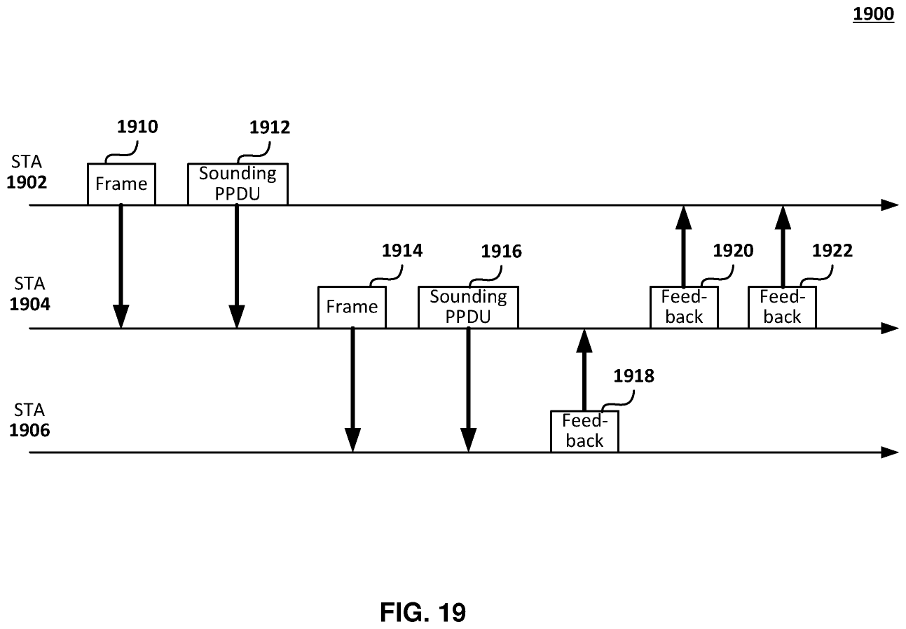

FIG. 19 is an example that illustrates a sounding procedure for relay communication according to an embodiment. Example 1900 is provided for the purpose of illustration only and is not limiting.

As shown in FIG. 19, example 1900 may include STAs 1902, 1904 and 1906. In an example, STAs 1904 and 1906 may be associated with STA 1902. STAs 1902, 1904, and/or 1906 may each comprise a multi-link device (MLD).

In an example, STA 1902 and STA 1904 may be within each other's communication ranges, STA 1902 and STA 1906 may be outside of each other's communication ranges, and, STA 1904 and STA 1906 may be within each other's communication ranges. In an example, STA 1902 may comprise an AP. In an example, STA 1902 may comprise a relay. In an example, the relay may comprise a relay AP and a relay STA. In an example, STA 1904 may comprise a mobile relay. In an example, STA 1906 may comprise a non-AP STA.

It is assumed in example 1900 that STA 1902 supports a relay sounding capability. In an example, support of the relay sounding capability allows STA 1902 to transmit a first frame (such as frame 1910 described below) indicating or announcing a first PPDU (such as a PPDU 1912 described below) to be transmitted by STA 1902; and indicating or triggering a second STA (such as STA 1904) to transmit to a third STA (such as STA 1906) a second frame (such as a frame 1914 described below) indicating or announcing a second PPDU (such as a PPDU 1916 described below) to be transmitted by the second STA to the third STA. In an embodiment, STA 1902 may comprise a beamformer. In an example, support of the relay sounding capability allows STA 1902 to transmit the first PPDU for estimation of a first channel from STA 1902 to the second STA after transmitting the first frame. In an example, support of the relay sounding capability allows STA 1902 to receive frames (such as frames 1920 and 1922 described below) from the second STA.

It is assumed in example 1900 that STA 1904 supports a relay sounding capability. In an example, support of the relay sounding capability allows STA 1904 to receive a first frame (such as frame 1910 described below) indicating or announcing a first PPDU (such as PPDU 1912 described below) to be transmitted by a second STA (such as STA 1902); and indicating or triggering STA 1904 to transmit to a third STA (such as STA 1906) a second frame (such as frame 1914 described below) indicating or announcing a second PPDU (such as PPDU 1916 described below) to be transmitted by STA 1904 to a third STA. In an embodiment, STA 1904 may comprise a beamformee. In an example, support of the relay sounding capability allows STA 1904 to transmit frames (such as frames 1920 and 1922 described below) to the second STA. In an embodiment, STA 1904 may comprise a beamformer. In an example, support of the relay sounding capability allows STA 1904 to transmit frames/PPDUs (such as frame 1914 and PPDU 1916 described below) to the third STA. In an example, support of the relay sounding capability allows STA 1904 to receive the first PPDU for estimation of a first channel from the second STA to STA 1904 after receiving the first frame. In an example, support of the relay sounding capability allows STA 1904 to transmit the second PPDU for estimation of a second channel from STA 1904 to the third STA after transmitting the second frame.

In an embodiment, prior to the beginning of example 1900, STAs 1902 and 1904 may exchange a first frame and a second frame (not shown in FIG. 19) to exchange capability information. In an embodiment, the first frame may comprise the capability information of STA 1902, including a first indication of support by STA 1902 of the relay sounding capability. In an embodiment, the second frame may comprise the capability information of STA 1904, including a second indication of support by STA 1904 of the relay sounding capability. In an embodiment, the first frame and the second frame may be exchanged after association between STA 1902 and 1904. In an embodiment, the first frame and the second frame may comprise a management frame.

As shown in FIG. 19, example 1900 may begin with STA 1902 transmitting to STA 1904 a frame 1910 to initiate a sounding sequence. In an example, the sounding sequence may comprise estimating a first channel from STA 1902 to STA 1904 and a second channel from STA 1904 to a STA 1906. In an example, the sounding sequence may comprise sounding for relaying communication. In an example, the sounding sequence may comprise reporting to STA 1902 feedback of the first/second channel.

In an embodiment, frame 1910 may indicate or announce a PPDU 1912 to be transmitted by STA 1902 to STA 1904. In an embodiment, frame 1910 may further indicate or trigger STA 1904 to transmit to STA 1906 a frame 1914. In an embodiment, frame 1914 may indicate or announce a PPDU 1916 to be transmitted by STA 1904 to STA 1906. In an embodiment, PPDU 1912 or 1916 may comprise a sounding PPDU. In an example, PPDU 1912 or 1916 may comprise an NDP.

In an embodiment, frame 1910 may solicit a frame 1920 and/or a frame 1922 from STA 1904. In an embodiment, frame 1914 may solicit a frame 1918 from STA 1906. In an example, frame 1910 may indicate a first feedback type for use by frame 1914 and/or a second feedback type for use by frames 1920 and/or 1922. In an example, the first feedback type or the second feedback type may indicate SU feedback, MU feedback, or CQI feedback. In an example, the second feedback type may be the same as the first feedback type. In another example, the second feedback type may be different from the first feedback type.

In an embodiment, SU feedback may comprise a compressed beamforming report. In an example, the compressed beamforming report may comprise average SNR of each spatial stream and compressed beamforming feedback matrices for use by a transmit beamformer to determine steering matrices for explicit feedback beamforming. In an embodiment, MU feedback comprises the compressed beamforming report and a MU exclusive beamforming report. In an example, the MU exclusive beamforming report may comprise explicit feedback in the form of delta SNRs. In an embodiment, CQI feedback may comprise CQI report. In an example, the CQI report may comprise per-RU average SNRs of each spatial stream. In an implementation, each per-RU average SNR may comprise an arithmetic mean of the SNR in decibels over the subcarriers of a 26-tone RU for which feedback is being requested.

In an embodiment, frame 1910 may comprise a control frame. In an example, the control frame may comprise an announcement frame. In an example, the announcement frame may comprise a NDP announcement (NDPA) frame. In an example, the NDPA frame may comprise an ultra-high reliability (UHR) NDPA frame.

After transmitting frame 1910, STA 1902 may transmit PPDU 1912 to STA 1904. In an embodiment, STA 1902 may transmit PPDU 1912 to STA 1904 a SIFS after transmitting frame 1910. In an embodiment, PPDU 1912 may be for estimation, by STA 1904, of a first channel from STA 1902 to STA 1904.

After receiving PPDU 1912 from STA 1902, STA 1904 may transmit frame 1914 to STA 1906. In an embodiment, STA 1904 may transmit frame 1914 to STA 1906 a SIFS after receiving PPDU 1912. In an example, frame 1914 may solicit frame 1918 from STA 1906. In an example, frame 1914 may indicate the second feedback type for use by frame 1918 based on an indication in frame 1910. In an embodiment, frame 1914 may comprise a control frame. In an example, the control frame may comprise an announcement frame. In an example, the announcement frame may comprise a NDP announcement (NDPA) frame. In an example, the NDPA frame may comprise an ultra-high reliability (UHR) NDPA frame.

After transmitting frame 1914, STA 1904 may transmit PPDU 1916 to STA 1906. In an embodiment, STA 1904 may transmit PPDU 1916 a SIFS after transmitting frame 1914. In an embodiment, PPDU 1916 may be for estimation, by STA 1906, of a second channel from STA 1904 to STA 1906.

After receiving PPDU 1916, STA 1906 may transmit frame 1918 to STA 1904. In an embodiment, STA 1906 may transmit frame 1918 a SIFS after receiving PPDU 1916. In an embodiment, frame 1918 may indicate a second estimate of the second channel. In an example, the second estimate may comprise second feedback based on PPDU 1916. In an example, the second feedback may comprise SU feedback or CQI feedback based on the second feedback type as indicated in frame 1914.

After receiving frame 1918, STA 1904 may transmit frame 1920 to STA 1902. Frame 1920 may be in response to frame 1910. In an embodiment, frame 1920 may comprise the second estimate of the second channel indicated in frame 1918. In an embodiment, frame 1920 may be for reporting the second feedback to STA 1902.

After transmitting frame 1920, STA 1904 may transmit to STA 1902 frame 1922. In an embodiment, frame 1922 may indicate a first estimate of the first channel. In an embodiment, the first estimate may comprise first feedback based on PPDU 1912. In an example, the first feedback may comprise SU feedback or CQI feedback based on the first feedback type as indicated in frame 1910.

In an embodiment, frame 1918, 1920, and/or 1922 may comprise a management frame. In an example, the management frame may comprise an action frame. In an example, frame 1922 may comprise a compressed beamforming report or a CQI report.

As shown in FIG. 19, in accordance with an embodiment, sounding of the end-to-end relay link between STA 1902 and 1906 may be achieved using a single sounding sequence. This may greatly reduce the overhead required for sounding as well as the latency for the relayed data, particularly when the first and/or second channel change frequently.

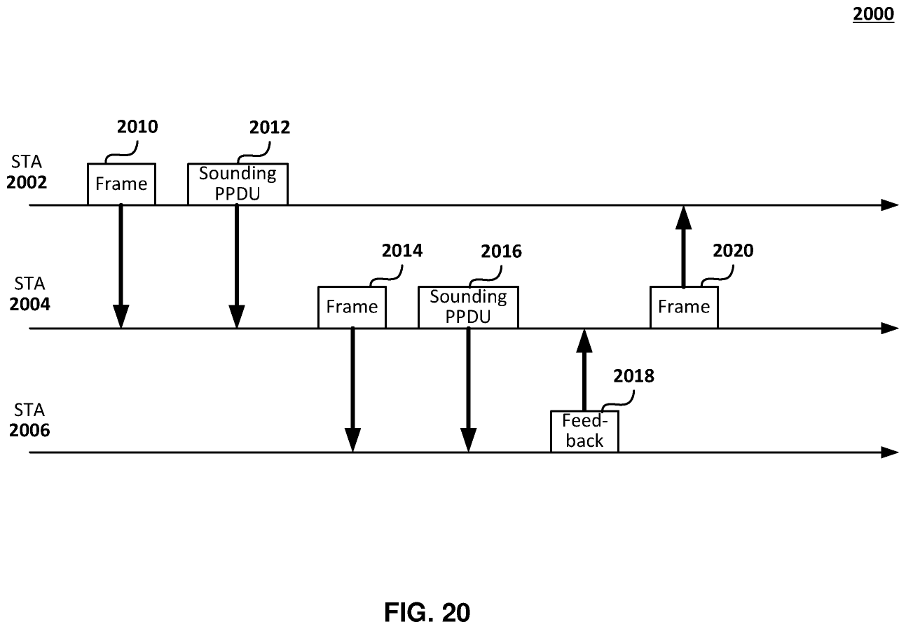

FIG. 20 is an example that illustrates a sounding procedure for relay communication according to an embodiment. Example 2000 is provided for the purpose of illustration only and is not limiting.

As shown in FIG. 20, example 2000 may include STAs 2002, 2004 and 2006. In an example, STAs 2004 and 2006 may be associated with STA 2002. STAs 2002, 2004, and/or 2006 may each comprise a multi-link device (MLD).

In an example, STA 2002 and STA 2004 may be within each other's communication ranges, STA 2002 and STA 2006 may be outside of each other's communication ranges, and, STA 2004 and STA 2006 may be within each other's communication ranges. In an example, STA 2002 may comprise an AP. In an example, STA 2002 may comprise a relay. In an example, the relay may comprise a relay AP and a relay STA. In an example, STA 2004 may comprise a mobile relay. In an example, STA 2006 may comprise a non-AP STA.

It is assumed in example 2000 that STA 2002 supports a relay sounding capability. In an example, support of the relay sounding capability allows STA 2002 to transmit a first frame (such as frame 2010 described below) indicating or announcing a first PPDU (such as a PPDU 2012 described below) to be transmitted by STA 2002; and indicating or triggering a second STA (such as STA 2004) to transmit to a third STA (such as STA 2006) a second frame (such as a frame 2014 described below) indicating or announcing a second PPDU (such as a PPDU 2016 described below) to be transmitted by the second STA to the third STA. In an embodiment, STA 2002 may comprise a beamformer. In an example, support of the relay sounding capability allows STA 2002 to transmit the first PPDU for estimation of a first channel from STA 2002 to the second STA after transmitting the first frame. In an example, support of the relay sounding capability allows STA 2002 to receive frames (such as a frame 2020 described below) from the second STA.

It is assumed in example 2000 that STA 2004 supports a relay sounding capability. In an example, support of the relay sounding capability allows STA 2004 to receive a first frame (such as frame 2010 described below) indicating or announcing a first PPDU (such as PPDU 2012 described below) to be transmitted by a second STA (such as STA 2002); and indicating or triggering STA 2004 to transmit to a third STA (such as STA 2006) a second frame (such as frame 2014 described below) indicating or announcing a second PPDU (such as PPDU 2016 described below) to be transmitted by STA 2004 to a third STA. In an embodiment, STA 2004 may comprise a beamformee. In an example, support of the relay sounding capability allows STA 2004 to transmit frames (such as a frame 2020 described below) to the second STA. In an embodiment, STA 2004 may comprise a beamformer. In an example, support of the relay sounding capability allows STA 2004 to transmit frames/PPDUs (such as frame 2014 and PPDU 2016 described below) to the third STA. In an example, support of the relay sounding capability allows STA 2004 to receive the first PPDU for estimation of a first channel from the second STA to STA 2004 after receiving the first frame. In an example, support of the relay sounding capability allows STA 2004 to transmit the second PPDU for estimation of a second channel from STA 2004 to the third STA after transmitting the second frame.

In an embodiment, prior to the beginning of example 2000, STAs 2002 and 2004 may exchange a first frame and a second frame (not shown in FIG. 20) to exchange capability information. In an embodiment, the first frame may comprise the capability information of STA 2002, including a first indication of support by STA 2002 of the relay sounding capability. In an embodiment, the second frame may comprise the capability information of STA 2004, including a second indication of support by STA 2004 of the relay sounding capability. In an embodiment, the first frame and the second frame may be exchanged after association between STA 2002 and 2004. In an embodiment, the first frame and the second frame may comprise a management frame.

As shown in FIG. 20, example 2000 may begin with STA 2002 transmitting to STA 2004 a frame 2010 to initiate a sounding sequence. In an example, the sounding sequence may comprise estimating a first channel from STA 2002 to STA 2004 and a second channel from STA 2004 to a STA 2006. In an example, the sounding sequence may comprise sounding for relaying communication. In an example, the sounding sequence may comprise reporting to STA 2002 feedback of the first/second channel.

In an embodiment, frame 2010 may indicate or announce a PPDU 2012 to be transmitted by STA 2002 to STA 2004. In an embodiment, frame 2010 may further indicate or trigger STA 2004 to transmit to STA 2006 a frame 2014. In an embodiment, frame 2014 may indicate or announce a PPDU 2016 to be transmitted by STA 2004 to STA 2006. In an embodiment, PPDU 2012 or 2016 may comprise a sounding PPDU. In an example, PPDU 2012 or 2016 may comprise an NDP.

In an embodiment, frame 2010 may solicit a frame 2020 from STA 2004. In an embodiment, frame 2014 may solicit a frame 2018 from STA 2006. In an example, frame 2010 may indicate a first feedback type for use by frame 2014 and/or a second feedback type for use by frames 2020 and/or 2022. In an example, the first feedback type or the second feedback type may indicate SU feedback, MU feedback, or CQI feedback. In an example, the second feedback type may be the same as the first feedback type. In another example, the second feedback type may be different from the first feedback type.

In an embodiment, SU feedback may comprise a compressed beamforming report. In an example, the compressed beamforming report may comprise average SNR of each spatial stream and compressed beamforming feedback matrices for use by a transmit beamformer to determine steering matrices for explicit feedback beamforming. In an embodiment, MU feedback comprises the compressed beamforming report and a MU exclusive beamforming report. In an example, the MU exclusive beamforming report may comprise explicit feedback in the form of delta SNRs. In an embodiment, CQI feedback may comprise CQI report. In an example, the CQI report may comprise per-RU average SNRs of each spatial stream. In an implementation, each per-RU average SNR may comprise an arithmetic mean of the SNR in decibels over the subcarriers of a 26-tone RU for which feedback is being requested.

In an embodiment, frame 2010 may comprise a control frame. In an example, the control frame may comprise an announcement frame. In an example, the announcement frame may comprise a NDP announcement (NDPA) frame. In an example, the NDPA frame may comprise an ultra-high reliability (UHR) NDPA frame.

After transmitting frame 2010, STA 2002 may transmit PPDU 2012 to STA 2004. In an embodiment, STA 2002 may transmit PPDU 2012 to STA 2004 a SIFS after transmitting frame 2010. In an embodiment, PPDU 2012 may be for estimation, by STA 2004, of a first channel from STA 2002 to STA 2004.

After receiving PPDU 2012 from STA 2002, STA 2004 may transmit frame 2014 to STA 2006. In an embodiment, STA 2004 may transmit frame 2014 to STA 2006 a SIFS after receiving PPDU 2012. In an example, frame 2014 may solicit frame 2018 from STA 2006. In an example, frame 2014 may indicate the second feedback type for use by frame 2018 based on frame 2010. In an embodiment, frame 2014 may comprise a control frame. In an example, the control frame may comprise an announcement frame. In an example, the announcement frame may comprise a NDP announcement (NDPA) frame. In an example, the NDPA frame may comprise an ultra-high reliability (UHR) NDPA frame.

After transmitting frame 2014, STA 2004 may transmit PPDU 2016 to STA 2006. In an embodiment, STA 2004 may transmit PPDU 2016 a SIFS after transmitting frame 2014. In an embodiment, PPDU 2016 may be for estimation, by STA 2006, of a second channel from STA 2004 to STA 2006.

After receiving PPDU 2016, STA 2006 may transmit frame 2018 to STA 2004. In an embodiment, STA 2006 may transmit frame 2018 a SIFS after receiving PPDU 2016. In an embodiment, frame 2018 may indicate a second estimate of the second channel. In an example, the second estimate may comprise second feedback based on PPDU 2016. In an example, the second feedback may comprise SU feedback or CQI feedback based on the second feedback type as indicated in frame 2014.

After receiving frame 2018, STA 2004 may transmit frame 2020 to STA 2002. Frame 2020 may be in response to frame 2010. In an embodiment, frame 2020 may indicate a first estimate of the first channel. In an embodiment, the first estimate may comprise first feedback based on PPDU 2012. In an example, the first feedback may comprise SU feedback or CQI feedback based on the first feedback type as indicated in frame 2010. In an embodiment, frame 2020 may comprise the second estimate of the second channel indicated in frame 2018. In an embodiment, frame 2020 may be for reporting the second feedback to STA 2002.

In an embodiment, frame 2018, and/or 2020 may comprise a management frame. In an example, the management frame may comprise an action frame. In an example, frame 2022 may comprise a compressed beamforming report or a CQI report.

As shown in FIG. 20, in accordance with an embodiment, sounding of the end-to-end relay link between STA 2002 and 2006 may be achieved using a single sounding sequence. This may greatly reduce the overhead required for sounding as well as the latency for the relayed data, particularly when the first and/or second channel change frequently.

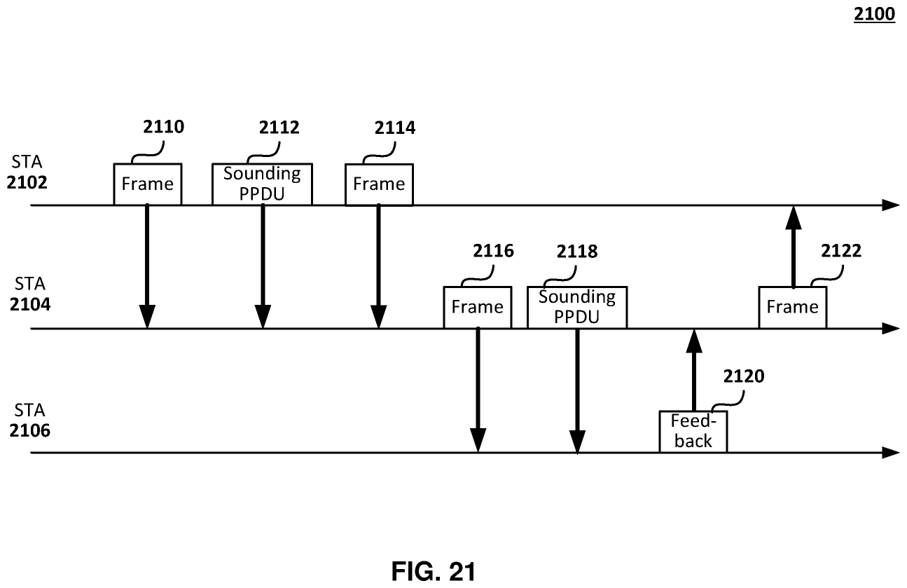

FIG. 21 is an example that illustrates a sounding procedure for relay communication according to an embodiment. Example 2100 is provided for the purpose of illustration only and is not limiting.

As shown in FIG. 21, example 2100 may include STAs 2102, 2104 and 2106. In an example, STAs 2104 and 2106 may be associated with STA 2102. STAs 2102, 2104, and/or 2106 may each comprise a multi-link device (MLD).

In an example, STA 2102 and STA 2104 may be within each other's communication ranges, STA 2102 and STA 2106 may be outside of each other's communication ranges, and, STA 2104 and STA 2106 may be within each other's communication ranges. In an example, STA 2102 may comprise an AP. In an example, STA 2102 may comprise a relay. In an example, the relay may comprise a relay AP and a relay STA. In an example, STA 2104 may comprise a mobile relay. In an example, STA 2106 may comprise a non-AP STA.

It is assumed in example 2100 that STA 2102 supports a relay sounding capability. In an embodiment, STA 2102 may comprise a beamformer. In an example, support of the relay sounding capability allows STA 2102 to transmit a first PPDU (such as PPDU 2112 described below) for estimation of a first channel from STA 2102 to the second STA. In an example, support of the relay sounding capability allows STA 2102 to receive a frame (such as a frame 2122 described below) from the second STA.

It is assumed in example 2100 that STA 2104 supports a relay sounding capability. In an embodiment, STA 2104 may comprise a beamformee. In an example, support of the relay sounding capability allows STA 2104 to receive from a second STA (such as STA 2102) a first PPDU (such as PPDU 2112 described below) for estimation of a first channel from the second STA to STA 2104. In an embodiment, STA 2104 may comprise a beamformer. In an example, support of the relay sounding capability allows STA 2104 to transmit to a third STA (such as STA 2106) a second PPDU (such as PPDU 2118 described below) for estimation of a second channel from STA 2104 to the third STA. In an embodiment, support of the relay sounding capability allows STA 2104 to receive from the third STA a frame (such as a frame 2120 described below) comprising a first estimate of the second channel. In an embodiment, support of the relay sounding capability allows STA 2104 to transmit to the second STA a frame (such as frame 2122) comprising: a second estimate of the first channel; and the first estimate of the second channel.

In an embodiment, prior to the beginning of example 2100, STAs 2102 and 2104 may exchange a first frame and a second frame (not shown in FIG. 21) to exchange capability information. In an embodiment, the first frame may comprise the capability information of STA 2102, including a first indication of support by STA 2102 of the relay sounding capability. In an embodiment, the second frame may comprise the capability information of STA 2104, including a second indication of support by STA 2104 of the relay sounding capability. In an embodiment, the first frame and the second frame may be exchanged after association between STA 2102 and 2104. In an embodiment, the first frame and the second frame may comprise a management frame.

As shown in FIG. 21, example 2100 may begin with STA 2102 transmitting to STA 2104 a frame 2110 to initiate a sounding sequence. In an example, the sounding sequence may comprise estimating a first channel from STA 2102 to STA 2104 and a second channel from STA 2104 to a STA 2106. In an example, the sounding sequence may comprise sounding for relaying communication. In an example, the sounding sequence may comprise reporting to STA 2102 feedback of the first/second channel.

In an embodiment, frame 2110 may indicate or announce a PPDU 2112 to be transmitted by STA 2102 to STA 2104.

In an embodiment, frame 2110 may comprise a control frame. In an example, the control frame may comprise an announcement frame. In an example, the announcement frame may comprise a NDP announcement (NDPA) frame. In an example, the NDPA frame may comprise an ultra-high reliability (UHR) NDPA frame.

After transmitting frame 2110, STA 2102 may transmit PPDU 2112 to STA 2104. In an embodiment, STA 2102 may transmit PPDU 2112 to STA 2104 a SIFS after transmitting frame 2110. In an embodiment, PPDU 2112 may be for estimation, by STA 2104, of a first channel from STA 2102 to STA 2104. In an embodiment, PPDU 2112 may comprise a sounding PPDU. In an example, PPDU 2112 may comprise an NDP.

After transmitting PPDU 2112, STA 2102 may transmit a frame 2114 triggering STA 2104 to transmit to STA 2106 a frame 2116. In an embodiment, STA 2102 may transmit frame 2114 to STA 2104 a SIFS after transmitting PPDU 2112.

In an embodiment, frame 2114 may solicit a frame 2122 from STA 2104. In an example, frame 2114 may indicate a first feedback type for use by frame 2122 and/or a second feedback type for use by frames 2120 and/or 2122. In an example, the first feedback type or the second feedback type may indicate SU feedback, MU feedback, or CQI feedback. In an example, the second feedback type may be the same as the first feedback type. In another example, the second feedback type may be different from the first feedback type.

In an embodiment, SU feedback may comprise a compressed beamforming report. In an example, the compressed beamforming report may comprise average SNR of each spatial stream and compressed beamforming feedback matrices for use by a transmit beamformer to determine steering matrices for explicit feedback beamforming. In an embodiment, MU feedback comprises the compressed beamforming report and a MU exclusive beamforming report. In an example, the MU exclusive beamforming report may comprise explicit feedback in the form of delta SNRs. In an embodiment, CQI feedback may comprise CQI report. In an example, the CQI report may comprise per-RU average SNRs of each spatial stream. In an implementation, each per-RU average SNR may comprise an arithmetic mean of the SNR in decibels over the subcarriers of a 26-tone RU for which feedback is being requested.

In an embodiment, frame 2114 may comprise a control frame. In an example, the control frame may comprise a trigger frame.

After receiving frame 2114 from STA 2102, STA 2104 may transmit frame 2116 to STA 2106. In an embodiment, STA 2104 may transmit frame 2116 to STA 2106 a SIFS after receiving frame 2114. In an embodiment, frame 2116 may indicate or announce a PPDU 2118 to be transmitted by STA 2104 to STA 2106. In an example, frame 2116 may solicit frame 2120 from STA 2106. In an example, frame 2116 may indicate the second feedback type for use by frame 2120 based on frame 2114.

In an embodiment, frame 2116 may comprise a control frame. In an example, the control frame may comprise an announcement frame. In an example, the announcement frame may comprise a NDP announcement (NDPA) frame.

After transmitting frame 2116, STA 2104 may transmit PPDU 2118 to STA 2106. In an embodiment, STA 2104 may transmit PPDU 2118 a SIFS after transmitting frame 2116. In an embodiment, PPDU 2118 may be for estimation, by STA 2106, of a second channel from STA 2104 to STA 2106. In an embodiment, PPDU 2118 may comprise a sounding PPDU. In an example, PPDU 2118 may comprise an NDP.

After receiving PPDU 2118, STA 2106 may transmit frame 2120 to STA 2104. In an embodiment, STA 2106 may transmit frame 2120 a SIFS after receiving PPDU 2118. In an embodiment, frame 2120 may indicate a second estimate of the second channel. In an example, the second estimate may comprise second feedback based on PPDU 2118. In an example, the second feedback may comprise SU feedback or CQI feedback based on the second feedback type as indicated in frame 2116.

After receiving frame 2120, STA 2104 may transmit frame 2122 to STA 2102. Frame 2122 may be in response to frame 2114. In an embodiment, frame 2122 may indicate a first estimate of the first channel. In an embodiment, the first estimate may comprise first feedback based on PPDU 2112. In an example, the first feedback may comprise SU feedback or CQI feedback based on the first feedback type as indicated in frame 2110. In an embodiment, frame 2122 may comprise the second estimate of the second channel indicated in frame 2120. In an embodiment, frame 2122 may be for reporting the first feedback and the second feedback to STA 2102.

In an embodiment, frame 2120, and/or 2122 may comprise a management frame. In an example, the management frame may comprise an action frame. In an example, frame 2122 may comprise a compressed beamforming report or a CQI report.

As shown in FIG. 21, in accordance with an embodiment, sounding of the end-to-end relay link between STA 2102 and 2106 may be achieved using a single sounding sequence. This may greatly reduce the overhead required for sounding as well as the latency for the relayed data, particularly when the first and/or second channel change frequently.

As shown in FIG. 21, in accordance with an embodiment, STA 2104 may enable sounding of the end-to-end relay link between STA 2102 and 2106 by combining the first estimate of the first channel and the second estimate of the second channel in a single frame 2122. This may reduce the latency for reporting the first feedback and the second feedback to STA 2102.

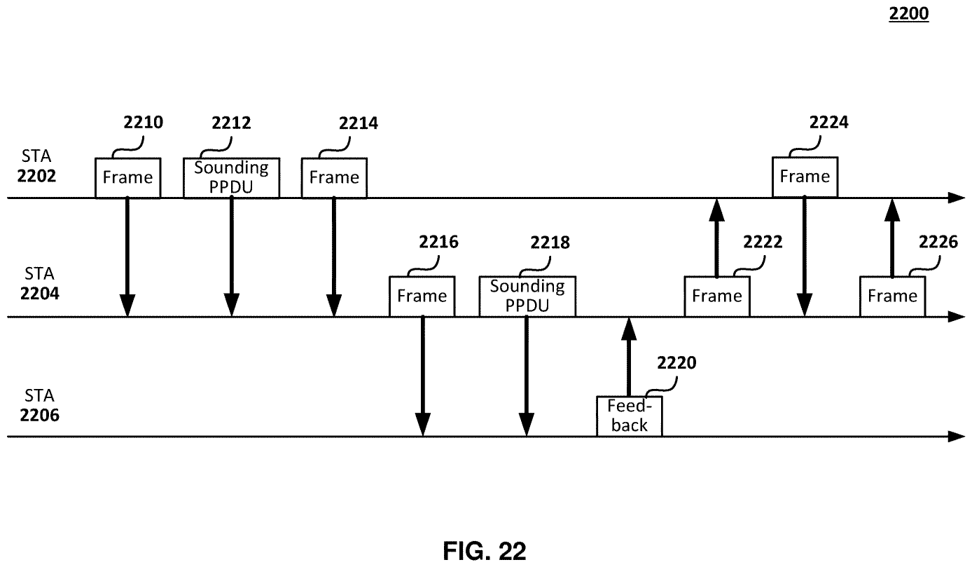

FIG. 22 is an example that illustrates a sounding procedure for relay communication according to an embodiment. Example 2200 is provided for the purpose of illustration only and is not limiting.

As shown in FIG. 22, example 2200 may include STAs 2202, 2204 and 2206. In an example, STAs 2204 and 2206 may be associated with STA 2202. STAs 2202, 2204, and/or 2206 may each comprise a multi-link device (MLD).

In an example, STA 2202 and STA 2204 may be within each other's communication ranges, STA 2202 and STA 2206 may be outside of each other's communication ranges, and, STA 2204 and STA 2206 may be within each other's communication ranges. In an example, STA 2202 may comprise an AP. In an example, STA 2202 may comprise a relay. In an example, the relay may comprise a relay AP and a relay STA. In an example, STA 2204 may comprise a mobile relay. In an example, STA 2206 may comprise a non-AP STA.

It is assumed in example 2200 that STA 2202 supports a relay sounding capability. In an embodiment, STA 2202 may comprise a beamformer. In an example, support of the relay sounding capability allows STA 2202 to transmit a first PPDU (such as PPDU 2212 described below) for estimation of a first channel from STA 2202 to the second STA. In an example, support of the relay sounding capability allows STA 2202 to receive frames (such as frames 2222 and 2226 described below) from the second STA. In an example, support of the relay sounding capability allows STA 2202 to transmit a frame (such as a frame 2224 described below) to the second STA.

It is assumed in example 2200 that STA 2204 supports a relay sounding capability. In an embodiment, STA 2204 may comprise a beamformee. In an example, support of the relay sounding capability allows STA 2204 to receive from a second STA (such as STA 2202) a first PPDU (such as PPDU 2212 described below) for estimation of a first channel from the second STA to STA 2204. In an embodiment, STA 2204 may comprise a beamformer. In an example, support of the relay sounding capability allows STA 2204 to transmit to a third STA (such as STA 2206) a second PPDU (such as PPDU 2218 described below) for estimation of a second channel from STA 2204 to the third STA. In an embodiment, support of the relay sounding capability allows STA 2204 to receive from the third STA a frame (such as a frame 2220 described below) comprising a first estimate of the second channel. In an embodiment, support of the relay sounding capability allows STA 2204 to transmit to the second STA frames (such as frames 2222 and 2226) comprising: a second estimate of the first channel; and the first estimate of the second channel. In an embodiment, support of the relay sounding capability allows STA 2204 to receive a frame (such as a frame 2224 described below) from the second STA.

In an embodiment, prior to the beginning of example 2200, STAs 2202 and 2204 may exchange a first frame and a second frame (not shown in FIG. 22) to exchange capability information. In an embodiment, the first frame may comprise the capability information of STA 2202, including a first indication of support by STA 2202 of the relay sounding capability. In an embodiment, the second frame may comprise the capability information of STA 2204, including a second indication of support by STA 2204 of the relay sounding capability. In an embodiment, the first frame and the second frame may be exchanged after association between STA 2202 and 2204. In an embodiment, the first frame and the second frame may comprise a management frame.

As shown in FIG. 22, example 2200 may begin with STA 2202 transmitting to STA 2204 a frame 2210 to initiate a sounding sequence. In an example, the sounding sequence may comprise estimating a first channel from STA 2202 to STA 2204 and a second channel from STA 2204 to a STA 2206. In an example, the sounding sequence may comprise sounding for relaying communication. In an example, the sounding sequence may comprise reporting to STA 2202 feedback of the first/second channel.

In an embodiment, frame 2210 may indicate or announce a PPDU 2212 to be transmitted by STA 2202 to STA 2204. In an example, frame 2210 may indicate a first feedback type for use by frame 2226. In an example, the first feedback type may comprise SU feedback, MU feedback, or CQI feedback.

In an embodiment, SU feedback may comprise a compressed beamforming report. In an example, the compressed beamforming report may comprise average SNR of each spatial stream and compressed beamforming feedback matrices for use by a transmit beamformer to determine steering matrices for explicit feedback beamforming. In an embodiment, MU feedback comprises the compressed beamforming report and a MU exclusive beamforming report. In an example, the MU exclusive beamforming report may comprise explicit feedback in the form of delta SNRs. In an embodiment, CQI feedback may comprise CQI report. In an example, the CQI report may comprise per-RU average SNRs of each spatial stream. In an implementation, each per-RU average SNR may comprise an arithmetic mean of the SNR in decibels over the subcarriers of a 26-tone RU for which feedback is being requested.

In an embodiment, frame 2210 may comprise a control frame. In an example, the control frame may comprise an announcement frame. In an example, the announcement frame may comprise a NDP announcement (NDPA) frame. In an example, the NDPA frame may comprise an ultra-high reliability (UHR) NDPA frame.

After transmitting frame 2210, STA 2202 may transmit PPDU 2212 to STA 2204. In an embodiment, STA 2202 may transmit PPDU 2212 to STA 2204 a SIFS after transmitting frame 2210. In an embodiment, PPDU 2212 may be for estimation, by STA 2204, of a first channel from STA 2202 to STA 2204. In an embodiment, PPDU 2212 may comprise a sounding PPDU. In an example, PPDU 2212 may comprise an NDP.

After transmitting PPDU 2212, STA 2202 may transmit a frame 2214 triggering STA 2204 to transmit to STA 2206 a frame 2216. In an embodiment, STA 2202 may transmit frame 2214 to STA 2204 a SIFS after transmitting PPDU 2212.

In an embodiment, frame 2214 may comprise a control frame. In an example, the control frame may comprise a trigger frame.

After receiving frame 2214 from STA 2202, STA 2204 may transmit frame 2216 to STA 2206. In an embodiment, STA 2204 may transmit frame 2216 to STA 2206 a SIFS after receiving frame 2214. In an embodiment, frame 2216 may indicate or announce a PPDU 2218 to be transmitted by STA 2204 to STA 2206. In an example, frame 2216 may solicit frame 2220 from STA 2206. In an example, frame 2216 may indicate the second feedback type for use by frame 2220 based on frame 2214.

In an example, frame 2216 may indicate a second feedback type for use by frames 2222 and 2226. In an example, the second feedback type may comprise SU feedback, MU feedback, or CQI feedback. In an example, the second feedback type may be the same as the first feedback type. In another example, the second feedback type may be different from the first feedback type.

In an embodiment, frame 2216 may comprise a control frame. In an example, the control frame may comprise an announcement frame. In an example, the announcement frame may comprise a NDP announcement (NDPA) frame.

After transmitting frame 2216, STA 2204 may transmit PPDU 2218 to STA 2206. In an embodiment, STA 2204 may transmit PPDU 2218 a SIFS after transmitting frame 2216. In an embodiment, PPDU 2218 may be for estimation, by STA 2206, of a second channel from STA 2204 to STA 2206. In an embodiment, PPDU 2218 may comprise a sounding PPDU. In an example, PPDU 2218 may comprise an NDP.

After receiving PPDU 2218, STA 2206 may transmit frame 2220 to STA 2204. In an embodiment, STA 2206 may transmit frame 2220 a SIFS after receiving PPDU 2218. In an embodiment, frame 2220 may indicate a second estimate of the second channel. In an example, the second estimate may comprise second feedback based on PPDU 2218. In an example, the second feedback may comprise SU feedback or CQI feedback based on the second feedback type as indicated in frame 2216.

After receiving frame 2220, STA 2204 may transmit frame 2222 to STA 2202. In an embodiment, STA 2204 may transmit frame 2222 a SIFS after receiving frame 2220. Frame 2222 may indicate STA 2204 received frame 2220. In an embodiment, frame 2222 may comprise a notification frame. In an embodiment, frame 2222 may comprise a contention free (CF) end frame. In another embodiment, frame 2222 may comprise a data frame.

After receiving frame 2222, STA 2202 may transmit a frame 2224 to STA 2204. In an embodiment, STA 2202 may transmit frame 2224 a SIFS after receiving frame 2222. In an embodiment, frame 2224 may solicit a frame 2226 from STA 2204.

After receiving frame 2224, STA 2204 may transmit frame 2226 to STA 2202. In an embodiment, STA 2204 may transmit frame 2226 a SIFS after receiving frame 2224. Frame 2226 may be in response to frame 2224. In an embodiment, frame 2226 may indicate a first estimate of the first channel. In an embodiment, the first estimate may comprise first feedback based on PPDU 2212. In an example, the first feedback may comprise SU feedback or CQI feedback based on the first feedback type as indicated in frame 2210. In an embodiment, frame 2222 may comprise the second estimate of the second channel indicated in frame 2220. In an embodiment, frame 2226 may be for reporting the first feedback and the second feedback to STA 2202.

In an embodiment, frame 2220, and/or 2226 may comprise a management frame. In an example, the management frame may comprise an action frame. In an example, frame 2222 may comprise a compressed beamforming report or a CQI report.

As shown in FIG. 22, in accordance with an embodiment, sounding of the end-to-end relay link between STA 2202 and 2206 may be achieved using a single sounding sequence. This may greatly reduce the overhead required for sounding as well as the latency for the relayed data, particularly when the first and/or second channel change frequently.

As shown in FIG. 22, in accordance with an embodiment, STA 2204 may enable sounding of the end-to-end relay link between STA 2202 and 2206 by combining the first estimate of the first channel and the second estimate of the second channel in a single frame 2222. This may reduce the latency for reporting the first feedback and the second feedback to STA 2202.

In an embodiment, frame 1810 described in FIG. 18, frame 1910 described in FIG. 19, and frame 2010 described in FIG. 20 may comprise a control frame. In an example, the control frame may comprise an announcement frame.

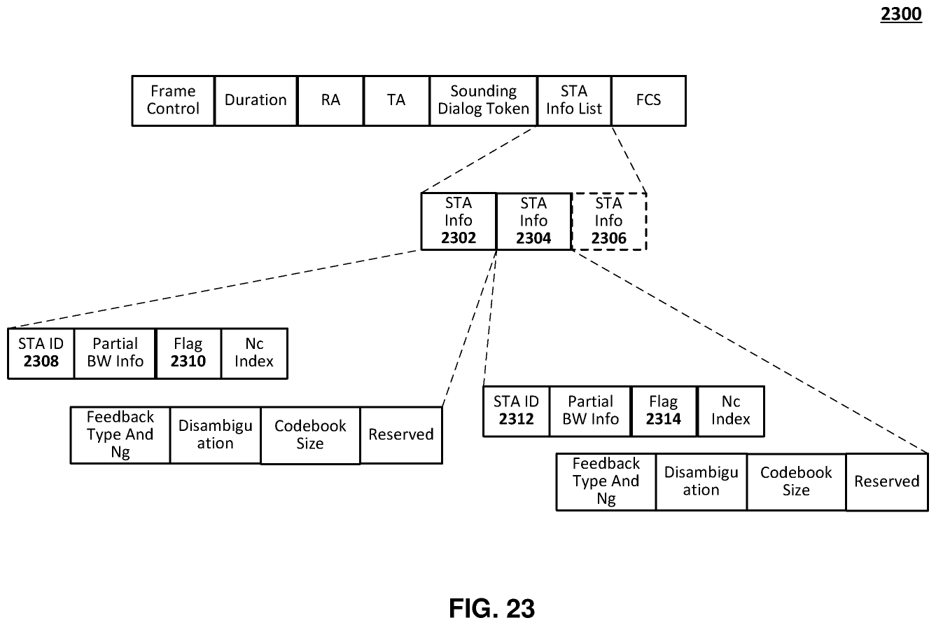

FIG. 23 illustrates an example announcement frame 2300 which may be used according to embodiments. For example, announcement frame 2300 may be an embodiment of frame 1810, 1910, or 2010.

In an embodiment, frame 2300 may be used by a first STA to indicate or announce a first PPDU for estimation, by a second STA, of a first channel from the first STA to the second STA and indicate or trigger the second STA to announce a second PPDU for estimation, by a third STA, of a second channel from the second STA to the third STA. For example, the first STA may comprise an embodiment of STA 2002 described in FIG. 20, STA 2102 described in FIG. 21, or STA 2202 described in FIG. 22. For example, the second STA may comprise an embodiment of STA 2004 described in FIG. 20, STA 2104 described in FIG. 21, or STA 2204 described in FIG. 22. For example, the third STA may comprise an embodiment of STA 2006 described in FIG. 20, STA 2106 described in FIG. 21, or STA 2206 described in FIG. 22. In an embodiment, frame 2300 may further be used by the first STA to indicate or trigger the second STA to announce the second PPDU for estimation, by a fourth STA, of a third channel from the second STA to the fourth STA.

As shown in FIG. 23, announcement frame 2300 may include a frame control field, a duration field, a receiver address (RA) field, a transmitter address (TA) field, a sounding dialog token field, a STA info list field, and an FCS field.

As shown in FIG. 23, the STA info list field of announcement frame 2300 may include a STA info field 2302, a STA info field 2304, and an optional STA info field 2306.

In an embodiment, STA info field 2302 comprises an STA ID subfield 2308, a partial BW info subfield, a flag subfield 2310, an Nc index subfield, a feedback type and Ng subfield, a disambiguation subfield, a codebook size subfield, and a reserved subfield. In an embodiment, STA info field 2302 may comprise first information for supporting relay sounding. In an embodiment, the first information may include an announcement of the first PPDU. In an embodiment, the announcement of the first PPDU may be provided in STA ID subfield 2308 and/or flag subfield 2310 of STA info field 2302.

For example, in an embodiment, STA ID subfield 2308 may indicate an identifier of the second STA. In an example, the identifier of the second STA may comprise an association identifier (AID) of the second STA. In an embodiment, flag subfield 2310 may indicate that STA info field 2302 is being used for announcing the first PPDU for estimation, by the second STA, of the first channel.

In an embodiment, flag subfield 2310 may indicate the presence of one or more following STA info field after STA info field 2302. For example, flag subfield 2310 may indicate the presence of STA info field 2304 being used for indicating or triggering the second STA as indicated in STA ID subfield 2308 to announce the second PPDU for estimation, by the third STA as indicated in STA info field 2304, of the second channel. In another example, flag subfield 2310 may further indicate the presence of STA info field 2306 being used for indicating or triggering the second STA as indicated in STA info field 2306 to announce the second PPDU for estimation, by the fourth STA as indicated in STA info field 2306, of the third channel.

As shown in FIG. 23, STA info field 2304 has a similar format as STA info field 2302. Particularly, STA info field 2304 may comprise a STA ID subfield 2312 and a flag subfield 2314.

In an embodiment, STA info field 2304 may comprise second information for supporting relay sounding. In an embodiment, the second information may include information for sending by the second STA to the third STA of an announcement of the second PPDU. In an embodiment, the announcement of the second PPDU may be provided in STA ID subfield 2312 and/or flag subfield 2314 of STA info field 2304.

In an embodiment, STA ID subfield 2312 may indicate the identifier of the third STA. In an example, the identifier of the third STA may comprise an AID of the third STA.

In an embodiment, flag subfield 2314 may indicate that STA info field 2304 is being used for sending by the second STA to the third STA of the announcement of the second PPDU for estimation, by the third STA, of the second channel, and that a STA info field (such as STA info field 2302), prior to STA info field 2304, is being used for announcing the first PPDU for estimation, by the second STA, of the first channel. In an embodiment, flag subfield 2314 may be set to a same value as flag subfield 2310 of STA info field 2302.

In an embodiment, frame 2300 may comprise a UHR NDPA frame for end-to-end relay sounding. In an example, the UHR NDPA frame for end-to-end relay sounding may comprise a UHR relay NDPA frame.

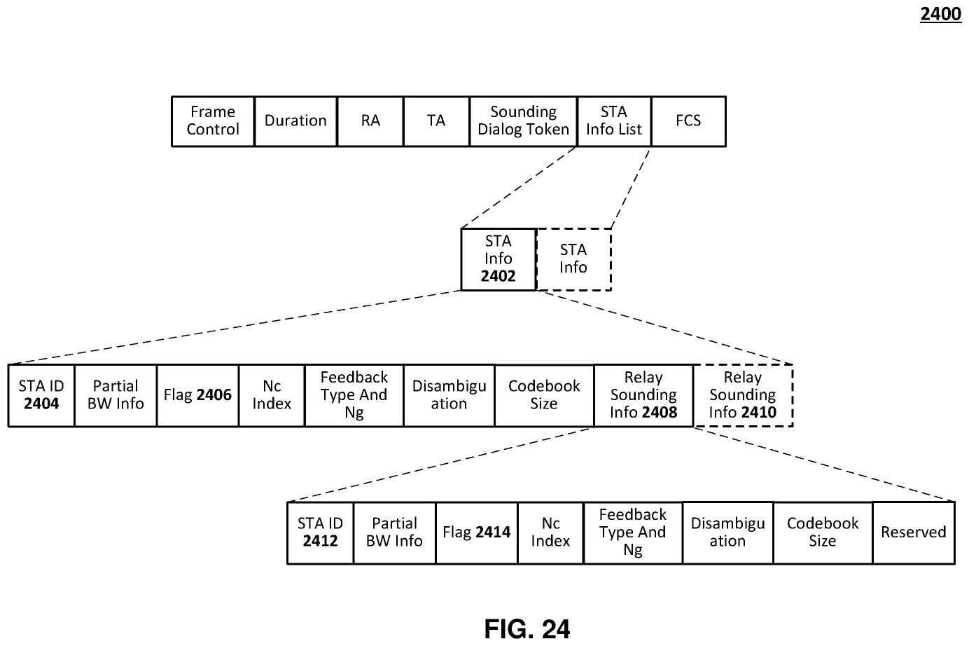

FIG. 24 illustrates an example control frame 2400 which may be used according to embodiments. For example, control frame 2400 may be an embodiment of frame 1810, 1910, or 2010 described above.

In an embodiment, control frame 2400 may be used by a first STA to indicate or announce a first PPDU for estimation, by a second STA, of a first channel from the first STA to the second STA and to indicate or trigger the second STA to announce a second PPDU for estimation, by a third STA, of a second channel from the second STA to the third STA. For example, the first STA may comprise an embodiment of STA 2002 described in FIG. 20, STA 2102 described in FIG. 21, or STA 2202 described in FIG. 22. For example, the second STA may comprise an embodiment of STA 2004 described in FIG. 20, STA 2104 described in FIG. 21, or STA 2204 described in FIG. 22. For example, the third STA may comprise an embodiment of STA 2006 described in FIG. 20, STA 2106 described in FIG. 21, or STA 2206 described in FIG. 22. In an embodiment, control frame 2400 may further be used by the first STA to indicate or trigger the second STA to announce the second PPDU for estimation, by a fourth STA, of a third channel from the second STA to the fourth STA.

As shown in FIG. 24, control frame 2400 may include a frame control field, a duration field, a receiver address (RA) field, a transmitter address (TA) field, a sounding dialog token field, a STA info list field, and an FCS field.

As shown in FIG. 24, the STA info list field may include one or more STA info field, including a STA info field 2402. STA info field 2402 may include a STA ID subfield 2404, a partial BW info subfield, a flag subfield 2406, an Nc index subfield, a feedback type and Ng subfield, a disambiguation subfield, a codebook size subfield, a relay sounding info subfield 2408, and an optional relay sounding info subfield 2410.

In an embodiment, STA info field 2402 may comprise information for supporting relay sounding. In an embodiment, the information for supporting relay sounding may include a first announcement of the first PPDU to be transmitted by the first STA and information for sending by the second STA to the third STA of a second announcement of the second PPDU.

In an embodiment, the first announcement of the first PPDU may be provided in STA ID subfield 2404 and/or flag subfield 2406. In an embodiment, STA ID subfield 2404 may indicate an identifier of the second STA. In an example, the identifier of the second STA may comprise an AID of the second STA. In an embodiment, flag subfield 2406 may indicate that STA info field 2402 includes the first announcement of the first PPDU and the information for sending the second announcement of the second PPDU.

In an embodiment, the information for sending the second announcement of the second PPDU may be provided in relay sounding info subfield 2408. In an embodiment, relay sounding info subfield 2408 includes a STA ID subfield 2412, a partial BW info subfield, a flag subfield 2414, a Nc index subfield, a feedback type and Ng subfield, a disambiguation subfield, a codebook size subfield, and a reserved subfield.

In an embodiment, STA ID subfield 2412 may indicate an identifier of the third STA. In an example, the identifier of the third STA may comprise an AID of the third STA.

In an embodiment, flag subfield 2414 may indicate that relay sounding info subfield 2408 includes the information for sending the second announcement of the second PPDU.

In an embodiment, flag subfield 2414 may indicate that relay sounding info subfield 2408 is being used for sending by the second STA to the third STA of the announcement of the second PPDU for estimation, by the third STA, of the second channel, and that subfields of STA info field 2402, prior to relay sounding info subfield 2408, are being used for announcing the first PPDU for estimation, by the second STA, of the first channel.

In an embodiment, flag subfield 2406 may further indicate that STA info field 2402 includes information for sending by the second STA to the fourth STA of a third announcement of the second PPDU for estimation, by the fourth STA, of a third channel from the second STA to the fourth STA. As such, STA info field 2402 may comprise relay sounding info subfield 2410 comprising the information for sending the third announcement. Relay sounding info subfield 2410 may have a similar format as relay sounding info subfield 2408 described above.

In an embodiment, control frame 2400 may comprise a UHR NDPA control frame for end-to-end relay sounding. In an example, UHR NDPA control frame for end-to-end relay sounding may comprise a UHR relay NDPA control frame or UHR enhanced NDPA control frame.

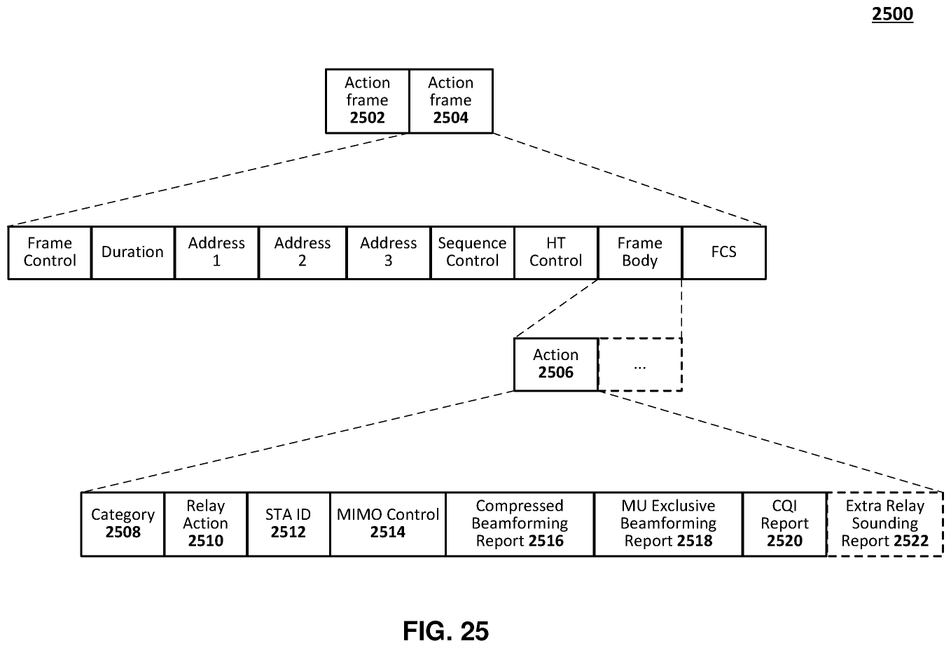

FIG. 25 illustrates an example action frame 2500 which may be used according to embodiments. For example, action frame 2500 may be an embodiment of frame 2020, 2122, or 2226. In an example, action frame 2500 may comprise a public action frame.

In an embodiment, action frame 2500 may be used by a first STA to report a first estimate of a first channel from a second STA to the first STA and a second estimate of a second channel from a first STA to the third STA. For example, the first STA may comprise an embodiment of STA 2004 described in FIG. 20, STA 2104 described in FIG. 21, or STA 2204 described in FIG. 22. For example, the second STA may comprise an embodiment of STA 2002 described in FIG. 20, STA 2102 described in FIG. 21, or STA 2202 described in FIG. 22. For example, the third STA may comprise an embodiment of STA 2006 described in FIG. 20, STA 2106 described in FIG. 21, or STA 2206 described in FIG. 22.

In an embodiment, the first estimate of the first channel may comprise a first feedback based on a first PPDU for estimation, by the first STA, of the first channel. In an embodiment, the first feedback may comprise a first beamforming report or a first channel quality indication (CQI) report. In an embodiment, the second estimate of the second channel may comprise a second feedback based on a second PPDU for estimation, by the third STA, of the second channel. In an embodiment, the second feedback may comprise a second beamforming report or a second CQI report.

In an embodiment, action frame 2500 may further be used by the first STA to report a third estimate of a third channel from the first STA to a fourth STA. In an embodiment, the third estimate of the third channel may comprise a third feedback based on a second PPDU for estimation, by the fourth STA, of the third channel. In an embodiment, the third feedback may comprise a third beamforming report or a third CQI report.

As shown in FIG. 25, action frame 2500 may comprise an aggregate frame. In an embodiment, action frame 2500 may aggregate an action frame 2502 and an action frame 2504.

In an embodiment, action frame 2502 may comprise first information for supporting relay sounding. In an embodiment, the first information may include the first estimate of the first channel.

In an embodiment, action frame 2502 may have a similar format as CQI frame 1400 described above. Particularly, action frame 2502 may include a frame control field, a duration field, one or more address fields, a sequence control field, an HT control field, a frame body, and an FCS field. In an embodiment, the frame body of action frame 2502 may include an action field. In an embodiment, the action field of action frame 2502 may include a category subfield that indicates that action frame 2502 is for sounding the first channel from the second STA to the first STA. In an example, the action field of action frame 2502 may comprise an EHT compressed beamforming/CQI action field or a UHR compressed beamforming/CQI action field.

In an embodiment, action frame 2504 may comprise second information for supporting relay sounding. In an embodiment, the second information may include one or more estimates associated with one or more STAs, such as the second estimate of the second channel associated with the third STA, and the third estimate of the third channel associated with the fourth STA.

As shown in FIG. 25, action frame 2504 may include a frame control field, a duration field, one or more address fields, a sequence control field, an HT control field, a frame body, and an FCS field. In an embodiment, the frame body of action frame 2504 may include an action field 2506. In an example, action field 2506 may comprise a relay compressed beamforming/CQI action field.

In an embodiment, action field 2506 may include a category subfield 2508 that indicates that action frame 2504 is for sounding one or more channels, such as the second channel from the first STA to the third STA and the third channel from the first STA to the fourth STA. In an example, category subfield 2508 may be set to a value for relay category.

In an embodiment, action field 2506 may further include a relay action field 2510, a STA ID field 2512, a MIMO control field 2514, a compressed beamforming report field 2516, an MU exclusive beamforming report field 2518, a CQI report field 2520, and an optional extra relay sounding report field 2522.

In an embodiment, relay action field 2510 may indicate a value for a compressed beamforming/CQI frame format associated with the second sounding of the second channel. In an example, the compressed beamforming/CQI frame format associated with the second sounding of the second channel may comprise a relay compressed beamforming/CQI frame format.

In an embodiment, STA ID field 2512, MIMO control field 2514, compressed beamforming report field 2516, MU exclusive beamforming report field 2518, and CQI report field 2520 may carry information associated with the sounding of the second channel.

In an embodiment, STA ID field 2512 may indicate an identifier of the third STA. In an example, the identifier of the third STA may comprise an AID of the third STA. In an example, the third STA may be associated with the second STA.

In an embodiment, MIMO control field 2514 may indicate MIMO control information associated with the sounding of the second channel. In an embodiment, the MIMO control information may comprise a Nc index subfield, a Nr index subfield, a BW subfield, a grouping subfield, a codebook Information subfield, a feedback type subfield, a remaining feedback segments subfield, a first feedback segment subfield, a partial BW info subfield, a sounding dialog token number subfield.

In an embodiment, compressed beamforming report field 2516 may indicate the second beamforming report. In an embodiment, compressed beamforming report field 2516 may carry average SNR of each spatial stream associated with the sounding of the second channel and compressed beamforming feedback matrices associated with the sounding of the second channel. In an example, the average SNR of each spatial stream and/or the compressed beamforming feedback matrices may be for use by a transmit beamformer (such as the first STA) to determine steering matrices for explicit feedback beamforming associated with the sounding of the second channel.

In an embodiment, MU exclusive beamforming report field 2518 may indicate the second beamforming report. In an embodiment, MU exclusive beamforming report field 2518 may carry explicit feedback in the form of delta SNRs associated with the sounding of the second channel. In an example, information in the compressed beamforming report field 2516 and information in the MU exclusive beamforming report field 2518 can be used by the transmit MU beamformer to determine the steering matrices associated with the sounding of the second channel when DL MU-MIMO is used for a transmission via second channel.

In an embodiment, CQI report field 2520 may indicate the second CQI report. In an embodiment, CQI report field 2520 may carry per-resource unit (RU) average SNRs of each spatial stream associated with the sounding of the second channel. In an embodiment, CQI report field 2520 may contain CQI report information associated with the sounding of the second channel. In an example, CQI report information may be included in the compressed beamforming/CQI report if the feedback type subfield in the MIMO control field 2514 indicates CQI feedback.

In an embodiment, extra relay sounding report field 2522 may be present and include information associated with the sounding of the third channel. In an embodiment, extra relay sounding report field 2522 have a similar format of fields as STA ID field 2512, MIMO control field 2514, compressed beamforming report field 2516, MU exclusive beamforming report field 2518, and CQI report field 2520 described above.

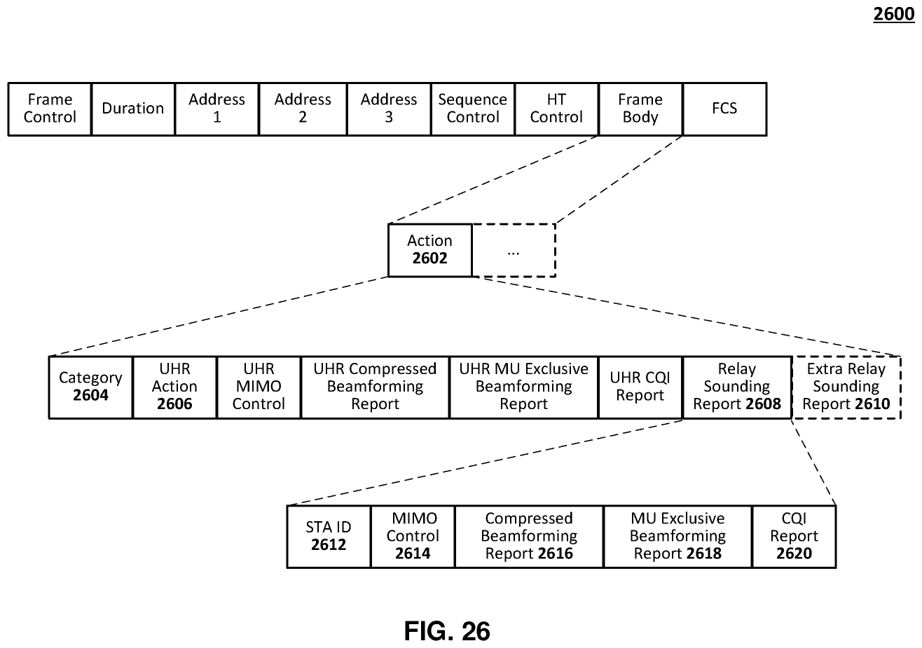

FIG. 26 illustrates an example action frame 2600 which may be used according to embodiments. For example, action frame 2600 may be an embodiment of frame 2020, 2122, or 2226. In an example, action frame 2600 may comprise a public action frame.

In an embodiment, action frame 2600 may be used by a first STA to report a first estimate of a first channel from a second STA to the first STA and a second estimate of a second channel from a first STA to the third STA. For example, the first STA may comprise an embodiment of STA 2004 described in FIG. 20, STA 2104 described in FIG. 21, or STA 2204 described in FIG. 22. For example, the second STA may comprise an embodiment of STA 2002 described in FIG. 20, STA 2102 described in FIG. 21, or STA 2202 described in FIG. 22. For example, the third STA may comprise an embodiment of STA 2006 described in FIG. 20, STA 2106 described in FIG. 21, or STA 2206 described in FIG. 22.

In an embodiment, the first estimate of the first channel may comprise a first feedback based on a first PPDU for estimation, by the first STA, of the first channel. In an embodiment, the first feedback may comprise a first beamforming report or a first CQI report. In an embodiment, the second estimate of the second channel may comprise a second feedback based on a second PPDU for estimation, by the third STA, of the second channel. In an embodiment, the second feedback may comprise a second beamforming report or a second CQI report.

In an embodiment, frame 2600 may further be used by the first STA to report a third estimate of a third channel from the first STA to a fourth STA. In an embodiment, the third estimate of the third channel may comprise a third feedback based on a second PPDU for estimation, by the fourth STA, of the third channel. In an embodiment, the third feedback may comprise a third beamforming report or a third CQI report.

As shown in FIG. 26, action frame 2600 may include a frame control field, a duration field, one or more address fields, a sequence control field, an HT control field, a frame body, and an FCS field.

As shown in FIG. 26, the frame body of action frame 2600 may include an action field 2602. In an embodiment, action field 2602 may comprise information for supporting relay sounding. In an embodiment, the information may include the first estimation of the first channel and the second estimate of the second channel. In an embodiment, the information may further include the third estimation of the third channel. In an example, action field 2602 may be a UHR sounding action field.

In an embodiment, action field 2602 may include a category subfield 2604 that indicates that action frame is for sounding the first channel from the second STA to the first STA and for sounding the second channel from the first STA to the third STA. In an embodiment, category subfield 2604 may further indicate that action frame is for sounding the third channel from the first STA to the fourth STA. In an example, action field 2602 may comprise an UHR compressed beamforming/CQI action field. In an example, category subfield 2604 may be set to a value for UHR category.

In an embodiment, action field 2602 may further include an action details field comprising an UHR action field 2606, an UHR MIMO control field, an UHR compressed beamforming report field, an UHR MU exclusive beamforming report field, and an UHR CQI report field, a relay sounding report field 2608, and an optional extra relay sounding report field 2610.

In an embodiment, UHR action field 2606 may indicate a value for a UHR compressed beamforming/CQI frame format associated with the sounding of the first channel and the sounding of the second channel. In an example, the UHR compressed beamforming/CQI frame format associated with the sounding of the first channel and the sounding of the second channel may comprise a UHR relay compressed beamforming/CQI frame format.

In an embodiment, relay sounding report field 2608 may comprise a STA ID field 2612, a MIMO control field 2614, a compressed beamforming report field 2616, an MU exclusive beamforming report field 2618, and a channel quality indication (CQI) report field 2620.

In an embodiment, the UHR MIMO control field, the UHR compressed beamforming report field, the UHR MU exclusive beamforming report field, and the UHR CQI report field may carry information associated with the sounding of the first channel.

In an embodiment, relay sounding report field 2608 may carry information associated with the sounding of the second channel.

In an embodiment, STA ID field 2612 may indicate an identifier of the third STA. In an example, the identifier of the third STA may comprise an AID of the third STA. In an example, the third STA may be associated with the second STA.

In an embodiment, MIMO control field 2614 may indicate MIMO control information associated with the sounding of the second channel. In an embodiment, the MIMO control information may comprise a Nc index subfield, a Nr index subfield, a BW subfield, a grouping subfield, a codebook Information subfield, a feedback type subfield, a remaining feedback segments subfield, a first feedback segment subfield, a partial BW info subfield, a sounding dialog token number subfield.

In an embodiment, compressed beamforming report field 2616 may carry average SNR of each spatial stream associated with the sounding of the second channel and compressed beamforming feedback matrices associated with the sounding of the second channel. In an example, the average SNR of each spatial stream and/or the compressed beamforming feedback matrices may be for use by a transmit beamformer (such as the first STA) to determine steering matrices for explicit feedback beamforming associated with the sounding of the second channel.

In an embodiment, MU exclusive beamforming report field 2618 may carry explicit feedback in the form of delta SNRs associated with the sounding of the second channel. In an example, information in compressed beamforming report field 2616 and information in MU exclusive beamforming report field 2618 can be used by the transmit MU beamformer to determine the steering matrices associated with the sounding of the second channel when DL MU-MIMO is used for a transmission via second channel.

In an embodiment, CQI report field 2620 may carry per-resource unit (RU) average SNRs of each spatial stream associated with the second sounding of the second channel. In an embodiment, CQI report field 2620 may contain CQI report information associated with the sounding of the second channel. In an example, CQI report information may be included in the compressed beamforming/CQI report if the feedback type subfield in MIMO control field 2614 indicates CQI feedback.

In an embodiment, extra relay sounding report field 2610 may be present and include information associated with the sounding of the third channel. In an embodiment, extra relay sounding report field 2610 have a similar format as relay sounding report field 2608 described above.

As would be understood by a person of skill in the art based on the teachings herein, the embodiments as described by the above examples may be readily extended to cases including more than three STAs.

As would be understood by a person of skill in the art based on the teachings herein, the embodiments as described by the above examples may be readily extended to cases including more than one relays.

As would be understood by a person of skill in the art based on the teachings herein, the embodiments as described by the above examples may be readily extended to cases including more than one non-AP STA.

As would be understood by a person of skill in the art based on the teachings herein, the embodiments as described by the above examples may be readily extended to scenarios in which any of the APs or any of the STAs may comprise an MLD, comprising at least one affiliated AP or affiliated STA.

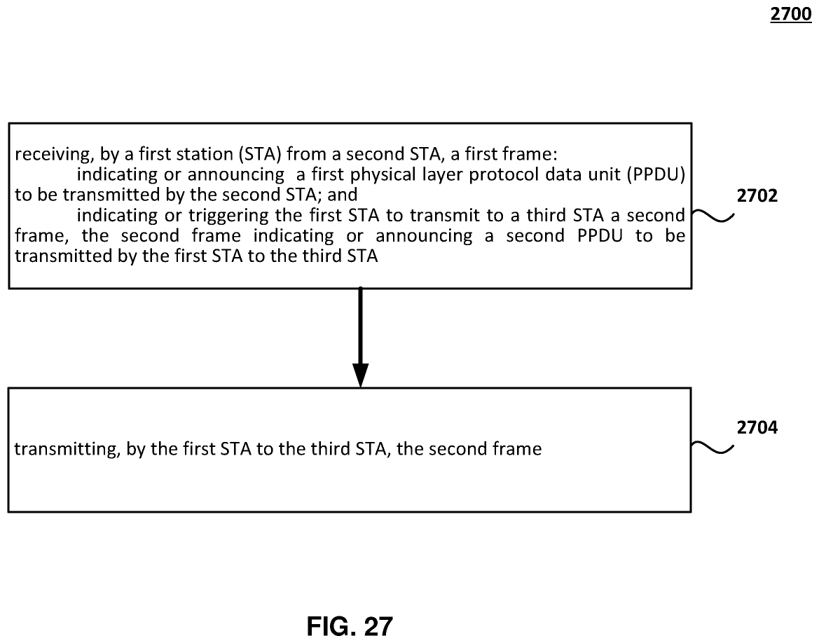

FIG. 27 illustrates an example process 2700 according to an embodiment. Example process 2700 is provided for the purpose of illustration only and is not limiting of embodiments. Process 2700 may be performed by a first AP.

As shown in FIG. 27, process 2700 begins in step 2702, which includes receiving, by a STA from a second STA, a first frame: indicating or announcing a first PPDU to be transmitted by the second STA; and indicating or triggering the first STA to transmit to a third STA a second frame, the second frame indicating or announcing a second PPDU to be transmitted by the first STA to the third STA.

In an embodiment, step 2702 further comprises: receiving, by the first STA from the second STA, the first PPDU; and transmitting, by the first STA to the third STA, the second PPDU.

In an embodiment, the first PPDU or the second PPDU comprises a sounding PPDU.

In an embodiment, the first PPDU or the second PPDU comprises a null data PPDU (NDP).

In an embodiment, the first PPDU is for estimation, by the first STA, of a first channel from the second STA to the first STA.

In step 2704, process 2700 includes transmitting, by the first STA to the third STA, the second frame.

In an embodiment, process 2700 further comprises: transmitting, by the first STA to the second STA, a third frame indicating a first estimate of the first channel.

In an embodiment, the first estimate comprises first feedback based on the first PPDU.

In an embodiment, transmitting the third frame comprises transmitting the third frame before or after transmitting the second frame.

In an embodiment, transmitting the third frame comprises transmitting the third frame a short interframe space (SIFS) before transmitting the second frame.

In an embodiment, transmitting the second frame comprises transmitting the second frame after receiving the first PPDU.

In an embodiment, transmitting the second frame comprises transmitting the second frame a SIFS after receiving the first PPDU.

In an embodiment, the second frame comprise a control frame comprising an announcement frame.

In an embodiment, the announcement frame comprises an NDP announcement frame.

In an embodiment, the second PPDU is for estimation, by the third STA, of a second channel from the first STA to the third STA.

In an embodiment, transmitting the second PPDU comprises transmitting the second PPDU after transmitting the third frame.

In an embodiment, transmitting the second PPDU comprises transmitting the second PPDU a SIFS after transmitting the third frame.

In an embodiment, process 2700 further comprises: receiving, by the first STA from the third STA, a fourth frame comprising a second estimate of the second channel; and transmitting, by the first STA to the second STA, a fifth frame comprising the second estimate.

In an embodiment, the second estimate comprises second feedback based on the second PPDU.

In an embodiment, the third frame comprises the fifth frame.

In an embodiment, the third frame, the fourth frame or the fifth frame comprises a management frame comprising an action frame.

In an embodiment, the action frame indicates a beamforming report or channel quality indication (CQI) report.

In an embodiment, the first frame comprises a control frame.

In an embodiment, the control frame comprises an announcement frame.

In an embodiment, the announcement frame comprises an NDP announcement frame.

In an embodiment, the control frame comprises a trigger frame.

In an embodiment, the first frame comprises an aggregate frame aggregating the announcement frame and the trigger frame.

In an embodiment, process 2700 further comprising: receiving, by the first STA from the second STA, a first indication of support by the second STA of a relay sounding capability; and transmitting, by the first STA to the second STA, a second indication of support by the first STA of the relay sounding capability.

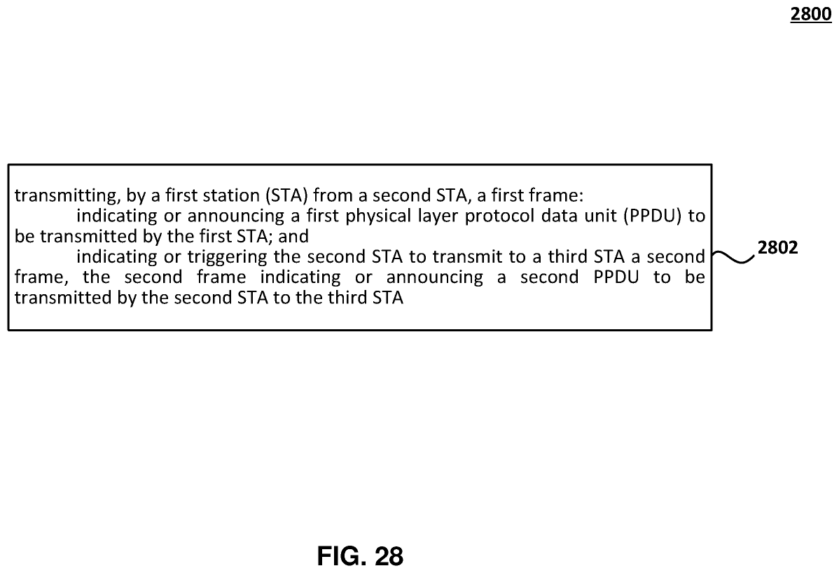

FIG. 28 illustrates an example process 2800 according to an embodiment. Example process 2800 is provided for the purpose of illustration only and is not limiting of embodiments. Process 2800 may be performed by a first AP.

As shown in FIG. 28, process 2800 begins in step 2802, which includes transmitting, by a STA to a second STA, a first frame: indicating or announcing a first PPDU to be transmitted by the first STA; and indicating or triggering the second STA to transmit to a third STA a second frame, the second frame indicating or announcing a second PPDU to be transmitted by the second STA to the third STA.

In an embodiment, step 2802 further comprises: transmitting, by the first STA to the second STA, the first PPDU.

In an embodiment, the first PPDU or the second PPDU comprises a sounding PPDU.

In an embodiment, the first PPDU or the second PPDU comprises a null data PPDU (NDP).

In an embodiment, the first PPDU is for estimation, by the second STA, of a first channel from the first STA to the second STA.

In an embodiment, process 2800 further comprises: receiving, by the first STA from the second STA, a third frame indicating a first estimate of the first channel.

In an embodiment, the first estimate comprises first feedback based on the first PPDU.

In an embodiment, indicating or triggering the second STA to transmit to the third STA the second frame comprises indicating or triggering the second STA to transmit to the third STA the second frame, after transmitting the first PPDU.

In an embodiment, indicating or triggering the second STA to transmit to the third STA the second frame comprises indicating or triggering the second STA to transmit to the third STA the second frame, a SIFS after transmitting the first PPDU.

In an embodiment, the second frame comprise a control frame comprising an announcement frame.

In an embodiment, the announcement frame comprises an NDP announcement frame.

In an embodiment, the second PPDU is for estimation, by the third STA, of a second channel from the first STA to the third STA.

In an embodiment, the second PPDU to be transmitted by the second STA to the third STA comprises the second PPDU to be transmitted by the second STA to the third STA, after receiving the third frame

In an embodiment, the second PPDU to be transmitted by the second STA to the third STA comprises the second PPDU to be transmitted by the second STA to the third STA, a SIFS after receiving the third frame.

In an embodiment, process 2800 further comprises: receiving, by the first STA from the second STA, a fourth frame comprising a second estimate of the second channel.

In an embodiment, the second estimate comprises second feedback based on the second PPDU.

In an embodiment, the third frame comprises the fourth frame.

In an embodiment, the third frame or the fourth frame comprises a management frame comprising an action frame.

In an embodiment, the action frame indicates a beamforming report or channel quality indication (CQI) report.

In an embodiment, the first frame comprises a control frame.

In an embodiment, the control frame comprises an announcement frame.

In an embodiment, the announcement frame comprises an NDP announcement frame.

In an embodiment, the control frame comprises a trigger frame.

In an embodiment, the first frame comprises an aggregate frame aggregating the announcement frame and the trigger frame.

In an embodiment, process 2800 further comprises: transmitting, by the first STA to the second STA, a first indication of support by the first STA of a relay sounding capability; and receiving, by the first STA from the second STA, a second indication of support by the second STA of the relay sounding capability.

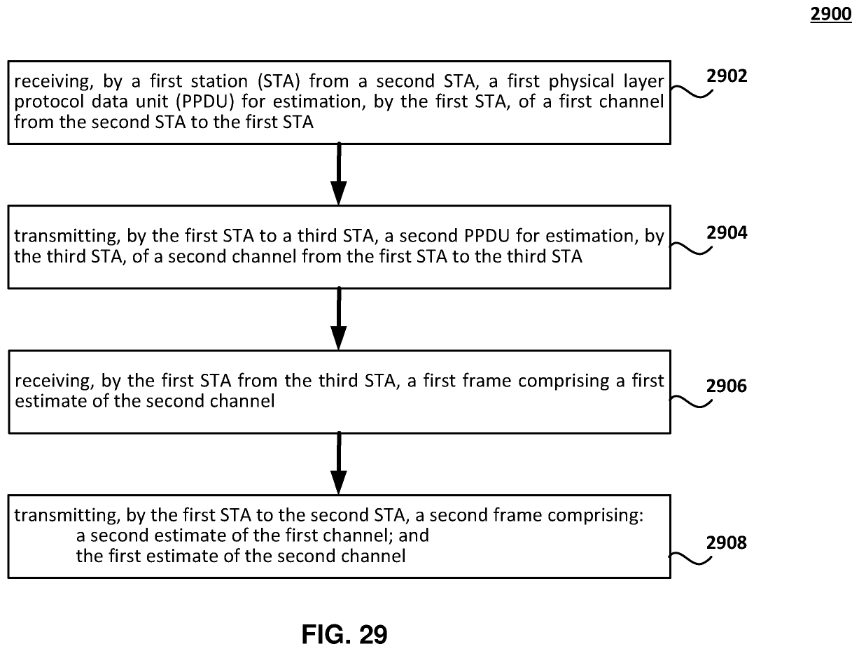

FIG. 29 illustrates an example process 2900 according to an embodiment. Example process 2900 is provided for the purpose of illustration only and is not limiting of embodiments. Process 2900 may be performed by a first AP.

As shown in FIG. 29, process 2900 begins in step 2902, which includes receiving, by a STA from a second STA, a first PPDU for estimation, by the first STA, of a first channel from the second STA to the first STA; transmitting, by the first STA to a third STA, a second PPDU for estimation, by the third STA, of a second channel from the first STA to the third STA; receiving, by the first STA from the third STA, a first frame comprising a first estimate of the second channel; and transmitting, by the first STA to the second STA, a second frame comprising: a second estimate of the first channel; and the first estimate of the second channel.

In an embodiment, the second estimate of the first channel comprises first feedback based on to the first PPDU.

In an embodiment, the first estimate of the second channel comprises second feedback based on to the second PPDU.

In an embodiment, the first PPDU or the second PPDU comprises a sounding PPDU.

In an embodiment, the first PPDU or the second PPDU comprises a null data PPDU (NDP).

In an embodiment, process 2900 further comprises: receiving, by the first STA from the second STA, a third frame soliciting from the first STA the second frame.

The method of claim 6, further comprising: transmitting, by the first STA to the second STA before receiving the third frame, a fourth frame indicating the first STA received the first frame.

In an embodiment, process 2900 further comprises: receiving, by the first STA from the second STA, a fifth frame announcing transmission of the first PPDU; receiving, by the first STA from the second STA, a sixth frame triggering the first STA to transmit to the third STA a seventh frame, after receiving the sixth frame, the seventh frame announcing transmission of the second PPDU; and transmitting, by the first STA to the third STA, the seventh frame.

In an embodiment, the first frame or second frame comprises a management frame comprising an action frame.

In an embodiment, the action frame indicates a beamforming report or channel quality indication (CQI) report.

In an embodiment, the third frame or the fourth frame comprises a control frame.

In an embodiment, the third frame comprises a trigger frame.

In an embodiment, the fourth frame comprises a contention free (CF) end frame.

In an embodiment, the fourth frame comprises a data frame.

In an embodiment, the fourth frame comprises a quality of service (QoS) null frame.

In an embodiment, process 2900 further comprises: receiving, by the first STA from the second STA, a first indication of support by the second STA of a relay sounding capability; and transmitting, by the first STA to the second STA, a second indication of support by the first STA of the relay sounding capability.

As would be understood by a person of skill in the art based on the teachings herein, the embodiments as described by the above examples may be readily extended to scenarios comprising: receiving, by a first station (STA) from a second STA, a first frame: soliciting transmission of a first physical layer protocol data unit (PPDU) from the first STA to the second STA; and triggering the first STA to transmit to a third STA a second frame, the second frame soliciting transmission of a second PPDU from a third STA to the first STA; transmitting, by the first STA to the second STA, the first PPDU in response to the first frame; transmitting, by the first STA to the third STA, the second frame; receiving, by the first STA from the third STA, the second PPDU in response to the second frame; and transmitting, by the first STA to the second STA, a third frame comprising an estimate of the second channel based on the second PPDU. In an embodiment, the first PPDU is for estimation of a first channel from the first STA to the second STA. In an embodiment, the second PPDU is for estimation of a second channel from the third STA to the first STA.

1. A first station (STA) comprising:
one or more processors, and
memory storing instructions that, when executed by the one or more processors, cause the first STA to:
receive, from a second STA, a first frame:
indicating a first sounding null data physical layer protocol data unit (NDP) to be transmitted by the second STA, and
indicating an NDP announcement frame to be transmitted by the first STA to a third STA, the NDP announcement frame:
indicating a second sounding NDP to be transmitted by the first STA to the third STA; and
indicating a feedback type for use by a second frame comprising feedback based on the second sounding NDP,
transmit, to the third STA, the NDP announcement frame;
transmit, to the third STA, the second sounding NDP; and
receive, from the third STA, the second frame.

2. The first STA of claim 1, wherein the second sounding NDP is for estimation, by the third STA, of a second channel from the first STA to the third STA.

3. The first STA of claim 1, wherein the feedback type comprises multi-user (MU) feedback.

4. The first STA of claim 1, wherein the feedback comprises a compressed beamforming report.

5. The first STA of claim 4, wherein the compressed beamforming report comprises compressed beamforming feedback matrices for use by the first STA to determine steering matrices.

6. The first STA of claim 1, wherein the instructions further cause the first STA to receive, from the second STA, a third frame indicating capability information of the second STA.

7. The first STA of claim 1, wherein the instructions further cause the first STA to transmit, to the second STA, a fourth frame indicating capability information of the first STA.

8. A first station (STA) comprising:
one or more processors, and
memory storing instructions that, when executed by the one or more processors, cause the first STA to:
transmit, to a second STA, a first frame:
indicating a first sounding null data physical layer protocol data unit (NDP) to be transmitted by the first STA; and
indicating an NDP announcement frame to be transmitted by the second STA to a third STA, the NDP announcement frame:
indicating a second sounding NDP to be transmitted by the second STA to the third STA; and
indicating a feedback type for use by a second frame comprising feedback based on the second sounding NDP.

9. The first STA of claim 8, wherein the second sounding NDP is for estimation, by the third STA, of a second channel from the second STA to the third STA.

10. The first STA of claim 9, wherein the feedback type comprises multi-user (MU) feedback.

11. The first STA of claim 9, wherein the feedback comprises a compressed beamforming report.

12. The first STA of claim 11, wherein the compressed beamforming report comprises compressed beamforming feedback matrices for use by the second STA to determine steering matrices.

13. The first STA of claim 8, wherein the instructions further cause the first STA to receive, from the second STA, a third frame indicating capability information of the second STA.

14. The first STA of claim 8, wherein the instructions further cause the first STA to transmit, to the second STA, a fourth frame indicating capability information of the first STA.

15. A non-transitory computer-readable medium comprising instructions that, when executed by one or more processors of a first station (STA), cause the first STA to:
receive, from a second STA, a first frame:
indicating a first sounding null data physical layer protocol data unit (NDP) to be transmitted by the second STA, and
indicating an NDP announcement frame to be transmitted by the first STA to a third STA, the NDP announcement frame:
indicating a second sounding NDP to be transmitted by the first STA to the third STA; and
indicating a feedback type for use by a second frame comprising feedback based on the second sounding NDP,
transmit, to the third STA, the NDP announcement frame;
transmit, to the third STA, the second sounding NDP; and
receive, from the third STA, the second frame.

16. The non-transitory computer-readable medium of claim 15, wherein the second sounding NDP is for estimation, by the third STA, of a second channel from the first STA to the third STA.

17. The non-transitory computer-readable medium of claim 15, wherein the feedback type comprises multi-user (MU) feedback.

18. The non-transitory computer-readable medium of claim 15, wherein the feedback comprises a compressed beamforming report.

19. The non-transitory computer-readable medium of claim 18, wherein the compressed beamforming report comprises compressed beamforming feedback matrices for use by the first STA to determine steering matrices.

20. The non-transitory computer-readable medium of claim 15, wherein the instructions further cause the first STA to receive, from the second STA, a third frame indicating capability information of the second STA.
